(19) United States
(12) Patent Application Publication
(10) Pub. No.: US 2012/0232985 A1
(43) Pub. Date: Sep. 13, 2012

(54) Advertising Using Mobile Devices

(75) Inventors: Zephrin I. Lasker, Brooklyn, NY (US); Roshan B. Bangera, Brooklyn, NY (US); Geoffrey B. Grauer, Brooklyn, NY (US); Brian C. Long, Wayne, PA (US); Nicholas P. Herman, Brooklyn, NY (US)

(73) Assignee: PONTILEX, INC., Brooklyn, NY (US)

(21) Appl. No.: 13/413,471

(22) Filed: Mar. 6, 2012

Related U.S. Application Data
(60) Provisional application No. 61/449,750, filed on Mar. 7, 2011.

(51) Int. Cl. G06Q 30/02

(52) U.S. Cl. 705/14.41

(57) ABSTRACT

One or more embodiments of the present invention relate to method, system and apparatus for presenting advertising on a mobile device within mobile device applications running thereon, collecting a user's response to the advertising, and distributing the responses to advertisers.

This patent application relates to U.S. Provisional Application No. 61/449,750 filed Mar. 7, 2011 from which priority is claimed under 35 USC §119(e), and which provisional application is incorporated herein in its entirety.

### CROSS-REFERENCE TO RELATED APPLICATIONS

This patent application is related to the following patent applications which are owned by the assignee of this patent application: application Ser. No. 11/801,330 filed May 9, 2007, and application Ser. No. 12/947,675 filed Nov. 15, 2010, both of which applications are incorporated by reference herein.

### TECHNICAL FIELD OF THE INVENTION

One or more embodiments of the present invention relate to method, system and apparatus for presenting advertising on a mobile device within mobile device applications running thereon, collecting a user's response to the advertising, and distributing the responses to advertisers.

### BACKGROUND

Digital media is rapidly creating a new set of platforms for use as vehicles for advertising. As is well known, one of the most widely developed of these platforms is the Internet. In the past, the Internet was primarily accessed via a desktop or laptop computer. However, digital media, and the Internet, in particular, is expanding into mobile telephones, tablet computers, desktop computers and other devices. This is allowing advertisers to extend their reach via these devices, and to communicate with potential customers wherever they may be.

Besides Internet web pages (based, for example, on HTML or other web-based markup languages), locally installed software applications (“apps”) are another way to provide functionality and tools for users of various digital devices. Advantageously, such apps can provide faster response times for users than web-based pages since they do not require constant Internet connectivity to function. This is because they are typically installed by users on their devices (such as mobile phones, tablet computers, desktop computers, and so forth).

Mobile phones equipped with Internet access and an ability to install applications have grown to represent a significant share of mobile phone sales in the United States. Examples of such mobile phones include the Apple® iPhone® mobile digital device, the Motorola® Droid mobile phone, and the HTC® Droid Incredible mobile phone. The Apple® iTunes® App Store^{SM} online store presently provides the largest market for apps, and is primarily focused on mobile phone apps, although the market for tablet apps that run on the Apple® iPad® mobile digital device is growing rapidly.

Presently, apps are increasingly being connected to the Internet to receive and send data, as needed. As such, and because these apps are connected to the Internet, they can receive and send advertising data. Hence, apps are rapidly emerging as a major new platform for digital advertising.

However, many of the devices on which apps run, from mobile phones to tablets, present constraints on advertisers, app developers and users. For one, such devices typically have smaller form factors than devices such as laptop or desktop computers, and thus, allow less screen “real estate” for advertising. Due to such constraints, many users (perhaps as many as 50%), due to the small form factor of mobile devices, click on mobile advertising by accidently touching the ads.

Additionally, most mobile advertising relies on a re-direct model wherein a user clicks on an ad, and the user is then re-directed from the app the user is using to a mobile web browser. Problematically, mobile web browsers are generally slow to load and require the user to wait while a page loads. This is due to a combination of low-powered hardware of a mobile device when compared to that of a laptop or desktop computer, and low bandwidth/latency connections of mobile networks. As such, most users prefer to stay within apps they are using rather than being re-directed to another interface (usually a web browser) because users dislike the interruption caused by being re-directed. Such user preference for minimal interruption applies not only to apps running on mobile devices, but extends to apps running on many other digital media devices. In an increasingly fragmented media-consumption environment, users try to balance the demands of a growing number of devices and formats. Due to this, most users prefer to minimize the number of interruptions that occur while they are using their devices.

A majority of mobile app downloads are free, i.e., their developers earn no money upon the apps' download. Mobile app developers provide such free applications in hopes of earning money from advertising running inside the apps. Unfortunately, current rates for mobile advertising inside apps are low, and fail to produce a suitable source of revenue for app developers. The rates are low because current user experiences for ads is very poor. In particular, current ads, when clicked upon, force a user to leave the app and go to a separate landing page in a web-browsing application. As described above, this ruins the app experience, and thus far has yielded very low-performing ad campaigns.

Recently, Apple Inc. has announced a potential solution to this issue, Apple® iAds^{SM} mobile advertising platform, which builds interactive advertisements that live completely inside an app. Rather than re-direct users to an internet-hosted, browser-served, landing page, the Apple® iAds^{SM} mobile advertising platform will direct users to an interactive experience inside the app. While this solution may work for brand advertisements which are focused solely on the user's actively engaging the brand, it does not address performance-based, direct-response advertisers that rely upon continued engagement with the consumer.

In addition to providing a user preferred experience, in-app ads portend greater revenue for app developers because, as more users interact with cost-per-lead, in-app ads, app developers can earn more money than with cost-per-click or cost-per-impression ads. In addition, advertisers will be incentivized to use ad formats that users prefer because advertisers also expect to benefit from in-app ads due to expected higher engagement rates. Advertisers want to build relationships with users, and that depends on engaging with users. This may be achieved by use of ad formats, such as in-app ads, that deliver a better user experience to enable higher user interaction rates.

### SUMMARY

In accordance with one or more embodiments of the present invention, a method is provided for presenting advertising to users of mobile applications on mobile devices, and collecting users' responses to the advertising. In accordance with one or more embodiments of the present invention, during operation of a mobile application (“app”), an in-app, sign-up Ad Unit is provided, and the in-app, sign-up Ad Unit collects self-reported user data without requiring the user to leave the mobile application. In accordance with one or more such embodiments, during operation of the mobile app, the user is presented offers in the form of one or more Ad Units from one or more Advertisers. In addition, the user is enabled to select one, or more than one, offer, by selecting checkboxes within Ad Units. In accordance with one or more further such embodiments, the user may fill in data fields in forms that may appear within Ad Units. Alternately, in accordance with one or more further such embodiments, the user may provide data during a registration process, then be presented with Ad Units displaying offers. Finally, the user may submit the data by clicking a submit button, and the data is automatically sent to Advertiser(s), for example, via a data transfer system or data bridge.

One embodiment of the present invention is an interface, for example and without limitation, a programmable interface which comprises a library of software modules (also referred to herein as an “Application Ad Library”), that enables the above-described functionality, where the software modules comprising the Application Ad Library execute within the mobile app. As a result, the user does not have to leave the mobile appl to receive and interact with advertisements.

One embodiment of the present invention is an SDK (“System Development Kit”) that enables a Developer to provide an Application Ad Library comprised of software modules that execute inside a mobile appl to access an Ad Server computer system and to access a data bridge between the mobile app and advertisers. In accordance with one or more embodiments of the present invention, the Ad Server computer system serves online advertising (in the form of Ad Units) on mobile devices during mobile app usage in the form of Ad Units. The mobile online Ad Units may comprise a registration page in which the user enters his/her contact information, and subsequent Ad Units which offer the user an opportunity to opt-in to sharing his/her contact information with Advertiser(s) for marketing purposes. The inventive SDK enables a Developer to provide software modules within the Application Ad Library that customize functional features of the ad delivery and data collection process as well as the look and feel of certain aspects thereof so they match a mobile app.

In accordance with one or more embodiments of the present invention, to configure mobile in-app advertising, a mobile app Developer would download an Application Ad Library from a source of application library files. Once downloaded, the mobile app Developer may configure the Application Ad Library so that one of its software modules creates a registration page inside the Developer's mobile app. In accordance with one such embodiment, the Application Ad Library may be configured so that one of its software modules launches the registration page on every instance in which the mobile app is launched. In such case, for example, the app will display a registration page requesting the user to enter his/her contact information—such user contact information may include the user's Name, Email, Zip Code, and any number of additional fields. In response to the registration page, the user would enter data corresponding to his/her contact information, and submit it, for example, by “clicking” an appropriate area of a screen display. In response, a software module in the Application Ad Library would check to ensure the user had correctly submitted information in all required fields. If the user had not correctly submitted information in each required field, a software module would prompt him/her to correct any mistakes detected. If the data was filled in correctly, a software module of the Application Ad Library would then display, for example, opt-in offer. Ad Units served from an Ad Server computer system. In response, the user may select one or more offers, and then submit them by “clicking” appropriate areas of a screen display. Upon submission, a software module of the Application Ad Library would send the user's registration information and information related to offers opted-into to a data bridge for subsequent transmission therefrom to each Advertiser whose advertisement was opted-into by the user.

### BRIEF DESCRIPTION OF THE DRAWINGS

FIG. 1 is a block diagram of a system architecture of a computer system that provides a data bridge for transferring data between Publishers/Developers and Advertisers.

FIGS. 2-4 show screens used to describe a data consumer configurator of the computer system shown in FIG. 1.

FIGS. 5-7 show screens used to describe a data source configurator of the computer system shown in FIG. 1.

FIGS. 8-11 show screens used to describe a data transfer configurator of the computer system shown in FIG. 1.

FIGS. 12-14 show diagrams used to describe data components that make up a Data Source Configuration, a Data Consumer Configuration and a Data Transfer Configuration, respectively, as stored in a configuration data store of the computer system shown in FIG. 1.

FIG. 15 shows an HTML source code view of a sample data source-owned HTML web page that includes a BrowserScriptPost code snippet useful for sending data to the computer system shown in FIG. 1.

FIG. 16 shows pseudo code describing a JavaScript function of a component of the BrowserScriptPost code snippet shown in FIG. 15.

There are no FIGS. 17-20.

FIG. 21 is a flow diagram showing a sequence of events from a user's perspective as the user interacts with an Ad Unit presented within a mobile device application, which Ad Unit and which method of user interaction are fabricated in accordance with one or more embodiments of the present invention.

FIG. 22 is a block diagram of components of an Ad Server computer system that is fabricated in accordance with one or more embodiments of the present invention.

FIG. 23 shows an Offer object that has been fabricated in accordance with one or more embodiments of the present invention and its relationship to a Data Transfer Configuration.

FIG. 24 shows an Offer Configuration web form that is fabricated in accordance with one or more embodiments of the present invention for use by an Advertiser in creating the Offer object shown in FIG. 23.

FIG. 25 shows a Data Source Registration Offer Screen and a RegistrationOffer object that are fabricated in accordance with one or more embodiments of the present invention.

FIG. 26 shows a Download Application Ad Configuration web form and an Application Ad Configuration that are fabricated in accordance with one or more embodiments of the present invention.

FIG. 27 shows Application Ad Library components that have been fabricated in accordance with one or more embodiments of the present invention.

FIG. 28 shows Application Ad Library screens that are generated in accordance with one or more embodiments of the present invention.

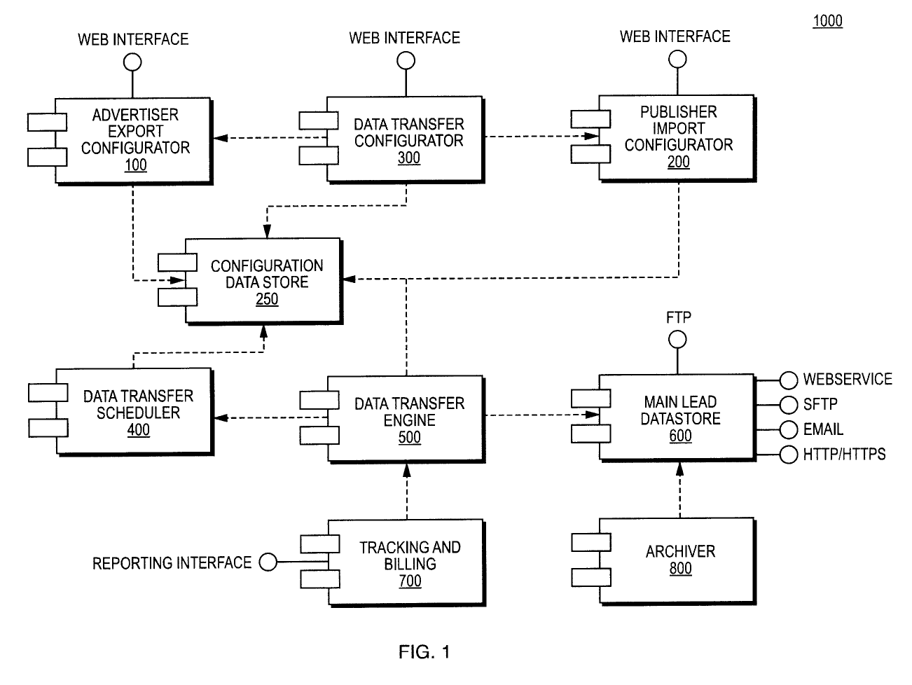

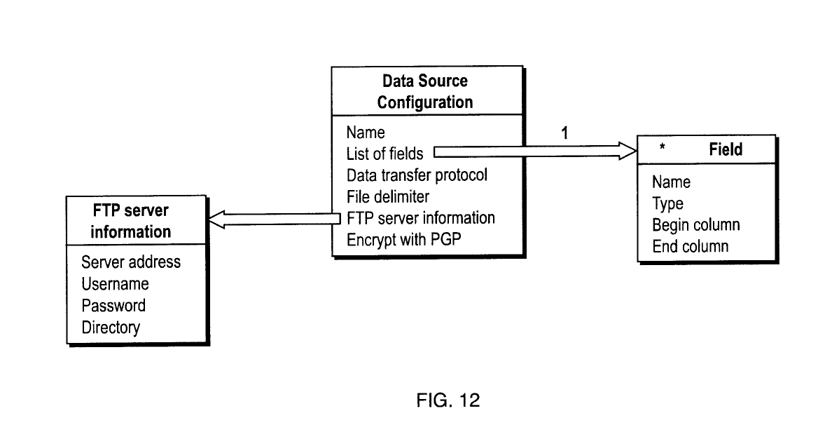

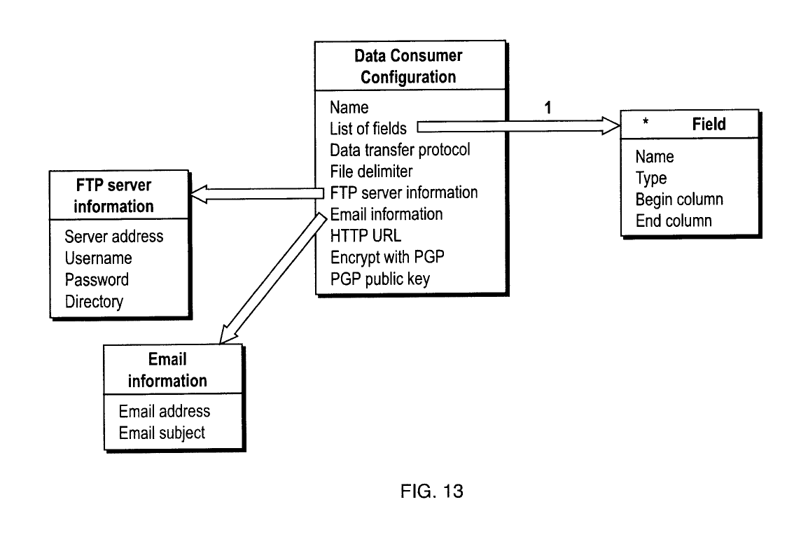

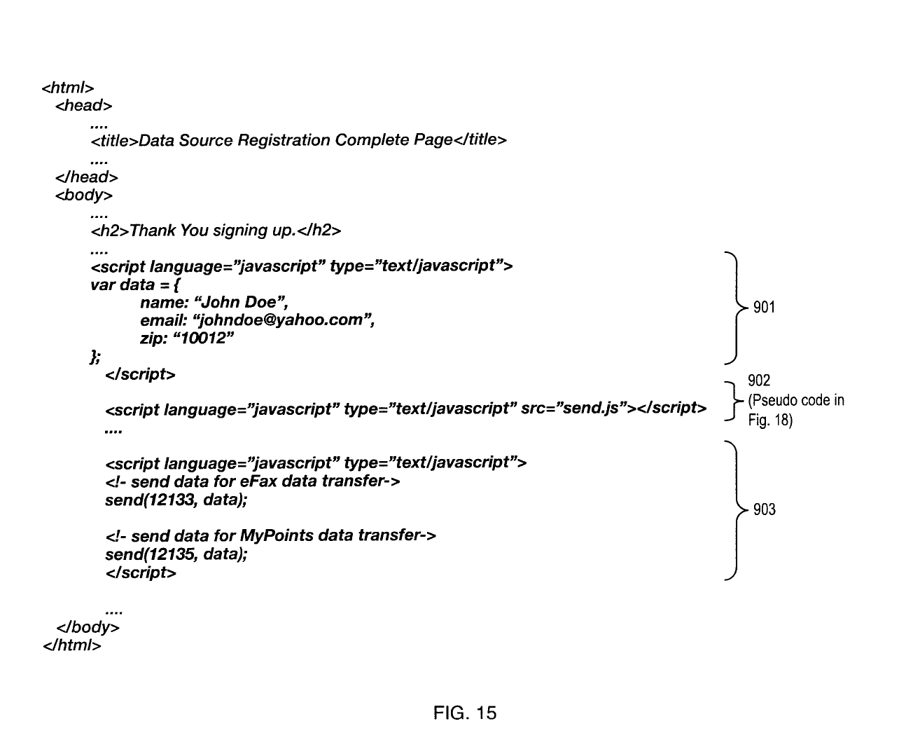

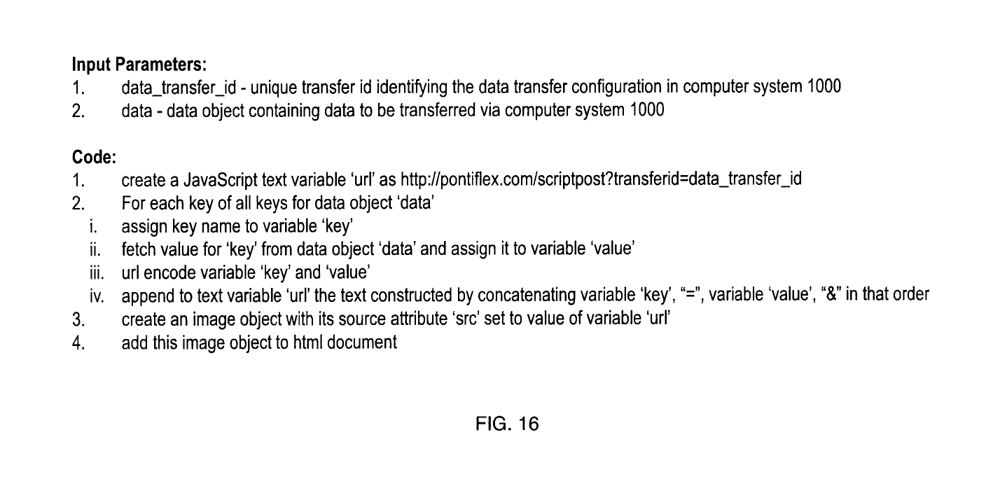

FIGS. 1-11 referenced above all come from, and have the same figure numbers assigned to them in, a U.S. patent application entitled “System and Method for Connecting and Managing Data Transfers Over the Internet,” having application Ser. No. 11/801,330, which application was filed on May 9, 2007, was published as U.S. Publication No. 2007/0294133A1 (referred to herein as the “Pontiflex Application”), and is assigned to the assignee of the present patent application, and which patent application and publication are incorporated by reference herein. FIGS. 12-14, 15 and 16 referenced above all come from the Pontiflex Application. In particular, FIGS. 12-14 of this application correspond to FIGS. 13-15 of the Pontiflex Application; FIG. 15 of this application corresponds to FIG. 17 of the Pontiflex Application; and FIG. 16 of this application corresponds to FIG. 18 of the Pontiflex Application.

### DETAILED DESCRIPTION

The Internet has become an important medium for advertising. In general, buyers and sellers of Internet advertising can be divided into two of the following categories: (a) Publishers (a Publisher is also referred to herein as a “data source”)—for example and without limitation, a Publisher is a website or a network of websites or a mobile phone network or a television network or a computer system or a mobile device application supplier (which mobile app is designed to run on a mobile device and which mobile app, in accordance with one or more embodiments of the present invention, can display Ad Units in the mobile app), or a mobile device running a mobile app and so forth that displays advertising units (“Ad Units”) on behalf of Advertisers (examples of Publishers are Aptimus, Valueclick, Verizon Wireless, Comcast Cable, New York Times Online, and Lycos); and (b) Advertisers (an Advertiser is also referred to herein as a “data consumer”)—for example and without limitation, an Advertiser is a company (selling one or more products and/or services) that contracts with a Publisher to display the Advertiser's ads or advertising units on the Publisher's sites (examples of Advertisers are HPShopping, Verisign, Circuit City and eFax). Although the above describes traditional Publishers, embodiments of the present invention also relate to Publishers of Ad Units on mobile devices and, in particular, to Publishers of Ad Units that are displayed, and from which data is captured and transmitted to, among others, Advertisers, within mobile applications (“apps”) that run on mobile devices. In addition, such the term Publisher may also include a Developer of a mobile app, which mobile app, in accordance with one or more embodiments of the present invention, can display Ad Units in the mobile app on a mobile device. In addition, the term Advertiser, when used in the context of receiving information from a Publisher, also refers to a computer system comprised of one or more computers that can receive information over the Internet. In particular, and as is described in more detailed herein, such Advertiser computer systems can receive information from a data bridge system over the Internet, which information was transmitted by Publishers to the data bridge computer system over the Internet in the manner described herein.

As is well known, common types of online advertising units (Ad Units) are, for example and without limitation, banners, buttons, opt-ins, email and paid search. In general, Publishers display Ad Units for Advertisers. In addition, and in general, prior art online Ad Units can be divided into two of the following categories, which categories are based on a method by which Advertisers collect data from a consumer of an Advertiser's product(s) or service(s): (a) re-directed Ad Units wherein a consumer clicks (using, for example, and without limitation, a user interaction device such as a computer mouse or a mobile device touch screen) on an Ad Unit, search result, or other Ad Unit displayed, for example, and without limitation, in a web browser on a user interface (for example, and without limitation, a computer display such as a screen of a mobile device or a monitor on a laptop computer of a notebook computer and the like) and is re-directed (for example and without limitation, either in a new browser window or by refreshing a current browser window) to an Advertiser's web form—the consumer then manually completes the web form by entering required data; and (b) Publisher-collected Ad Units wherein the consumer takes some action (for example and without limitation, checking or leaving checked, a pre-selected check-box—often during a website registration process) that causes the Publisher to transfer the consumer's data in the background to the Advertiser. However, in accordance with the present invention, Ad Units are presented to a user of a mobile device (for example, and without limitation, on the mobile device display screen) within his/her mobile application (“app”), and the user interacts with the Ad Unit (using, for example and without limitation, a mobile device touch screen and/or input device) without leaving the mobile app. For this reason, the term consumer will be taken to include the term user, and the term user includes the term consumer.

In accordance with one or more embodiments of the present invention, a programmable interface comprised of a library of software modules (referred to herein as an “Application Ad Library”) is made available to a mobile device app, wherein the software modules in the Application Ad Library enable a Publisher to provide, for example and without limitation, cost-per-lead (“CPL”) advertising (i.e., where a user signs up, and thereby, provides a lead, and the Publisher is compensated for each such lead) inside the mobile app. As used herein, the term Application Ad Library and software modules in the Application Ad Library are used to refer to software modules in the Application Ad Library. In accordance with one or more such embodiments of the present invention, the Application Library enables Ad Units obtained from an Ad Server to collect user lead data (for example and without limitation, self-reported, personal information data) for multiple Advertisers within an Ad Unit. In accordance with one or more such embodiments, the user is enabled to select one, or more than one, Advertiser's offer by selecting checkboxes displayed within the Ad Unit on the mobile device display. Then, the user may submit the data by “clicking” a submit button (as used herein the term clicking means clicking a mouse, depressing a finger on a touch screen, and any way an indication of a selection can be made using a mobile device), and the Application Ad Library causes the mobile device to send the data automatically to the Advertiser(s), for example, and without limitation, via a data transfer system such as the Pontiflex™ data transfer system available from Pontiflex, Inc. of Brooklyn, N.Y. Thus, in accordance with one or more such embodiments, a user can opt-in to an Advertiser's marketing program by providing her/his contact information to that Advertiser. In accordance with one or more such embodiments, the software modules in the Application Ad Library are executed on the mobile device as part of the mobile app so that the user does not need to leave the mobile app to interact with the Ad Units. Therefore, the user can sign up and quickly return to the mobile app.

One or more embodiments of the present invention are useful to mobile app Developers, Advertisers, Publishers and Consumers. Developers benefit by being able to be compensated when users opt-in to ads. Advertisers benefit by being able to collect interested customers' contact information (so-called “lead data”) instead of having customers' click and being re-directed to a website, which re-direction might never convert into the customers taking an action or signing-up—beneficially, lead data can be reused and remarketed. Publishers benefit by receiving a higher payout for their advertising real estate—most Internet Publishers rely on advertising to fund their operations, and a drop in yields from advertising revenue can adversely affected many Publishers. In accordance with one or more embodiments of the present invention, because a consumer can select multiple Advertisers' offers within the same Ad Unit, the Publisher can be paid by multiple Advertisers rather than just one—thereby multiplying the yield of an Ad Unit. When a consumer selects more than one offer this can multiply the payout the Publisher obtains from that Ad Unit (based, for example, on how many offers the consumer selects). Users (or consumers) benefit for several reasons. Users (or consumers) can opt-in to multiple Advertisers' offers instead of having to find and opt-in one-at-a-time—thereby gaining convenience and efficiency. Users (or consumers) are not redirected away from their mobile app because they are opting-in to receive information from the Advertiser(s) in their mobile app, and they are not being driven directly to an Advertiser's website.

One or more embodiments of the present invention use a Pontiflex™ data transfer system (described for example, in a U.S. patent application entitled “System and Method for Connecting and Managing Data Transfers Over the Internet,” having application Ser. No. 11/801,330, which application was filed May 9, 2007, was published as U.S. Publication No. 2007/0294133A1, and is assigned to the assignee of the present patent application, which patent application and publication are incorporated by reference herein, and which patent application is referred to herein as the “Pontiflex Application”) to manage routing and delivery of data from Ad Units to various Advertisers. Relevant aspects of the Pontiflex™ data transfer system are described herein in the Appendix. Beneficially, by using the Pontiflex™ data transfer system, data is delivered directly from Ad Units in a mobile application to Advertiser(s) with no additional work required by Publishers.

As described in the Appendix, and as shown in FIG. 1 (this is also FIG. 1 of the Pontiflex Application), the Pontiflex™ data transfer system is a computer system (computer system 1000) that provides a data bridge connecting Publishers (a Publisher is also referred to herein as a “data source” and may include a computer system or a mobile device referred to as a Publisher computer system or as a Publisher) to Advertisers (an Advertiser is also referred to herein as a “data consumer” and may include a computer system referred to as an Advertiser computer system or as an Advertiser) to transfer data between them as well as Publishers to Developers. In particular, the Pontiflex™ data transfer system mediates data transfers so that data sources (i.e., computer systems and mobile devices) can connect to computer system 1000 (shown in FIG. 1) in their preferred data transfer protocols to send data, and data consumers (i.e., computer systems) can build connections to computer system 1000 in their preferred data transfer protocols to receive data. By converting data received from data sources into data sent to data consumers, computer system 1000 provides a flexible “data bridge” that enables simple connectivity between parties, immediate delivery of customer data, and lowered cost of doing business.

As further described in the Appendix, computer system 1000 integrates online data transfers (typically comprised of data provided by consumers such as, for example and without limitation, name, email address, zip code, credit card number, or other information) between Publishers and Advertisers using a set up process. Once the set up process is complete, computer system 1000 translates data received from a Publisher (i.e., a data source) and sends the data to an Advertiser (i.e., a data consumer) by automatically recognizing a data output format provided by the Publisher and converting that information into a data input format required by the Advertiser.

As further described in the Appendix, a data source has an option to send data to computer system 1000 using a BrowserScriptPost code snippet that is generated by computer system 1000, and is available to be downloaded by the data source via a computer-system-provided web interface (alternatively, computer system 1000 may provide the BrowserScriptPost code snippet by email or a user of computer system 1000 may cause the BrowserScriptPost code snippet to be downloaded manually).

User Interaction Flow:

The Application Ad Library enables developers of mobile applications for use, for example and without limitation, with smartphones like the Apple® iPhone® mobile digital device, the Motorola® Droid mobile phone, and so forth to connect with Advertisers. In accordance with one or more embodiments of the present invention, an Ad Server computer system (also referred herein as an Ad Server) serves advertising from Advertisers to mobile apps running on mobile devices during users (or customers) usage of the mobile apps. As is described herein, software modules in the Application Ad Library run in the mobile app executing on the mobile device, and ask for Ads to be served to the mobile app from the Ad Server computer system (as will explained below, the Ad Server computer system can optimize the choice of Ads to serve), and, when a user opts-in to such Ads, software modules in the Application Ad Library cause the mobile device to send this information to a data transfer system. The data transfer system, in turn, sends the information to the Advertisers.

As one of ordinary skill in the art can readily appreciate, mobile apps and software modules that execute within mobile apps are software modules that execute on mobile device hardware such as, for example and without limitation, mobile device CPU(s), mobile device memory, mobile device data storage, mobile device display apparatus, and mobile device user input device such as keyboard and/or touch screen.

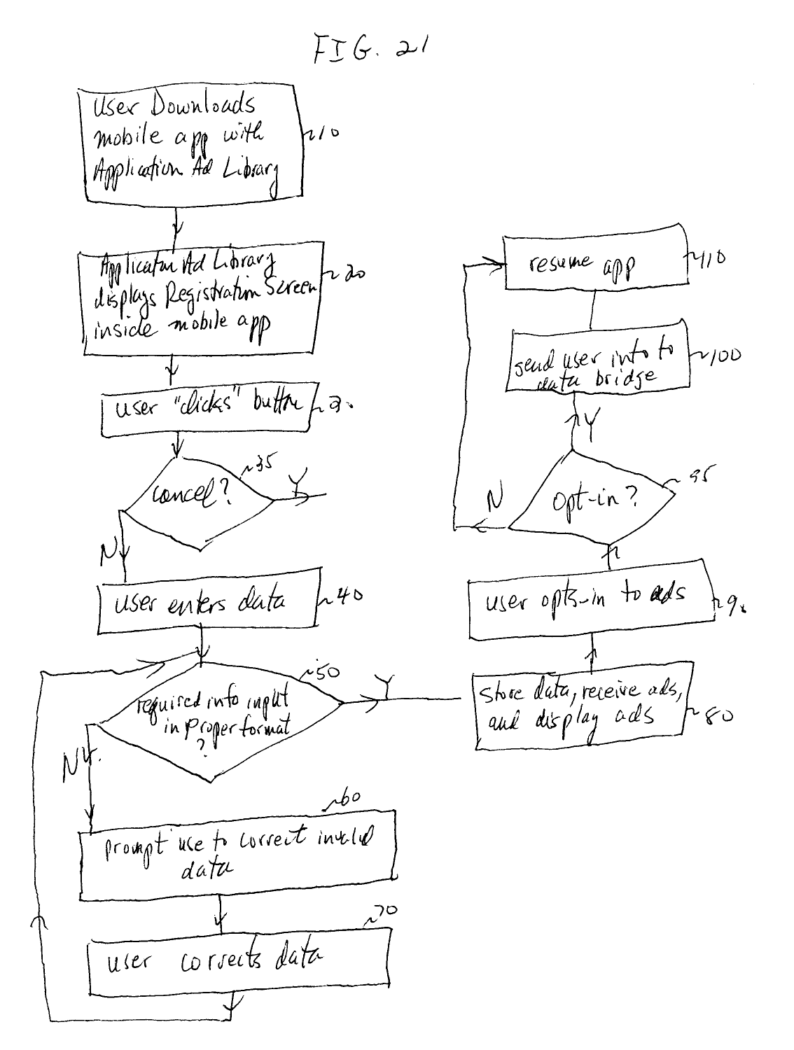

FIG. 21 is a flow diagram showing a sequence of events from a user's perspective as the user interacts with an Ad Unit presented within a mobile device application, which Ad Unit and which method of user interaction are fabricated in accordance with one or more embodiments of the present invention. At step 10 shown in FIG. 21, the user causes the mobile device to download and install a mobile application (“mobile app”) on the mobile device, which mobile app includes an Application Ad Library that has been fabricated in accordance with one or more embodiments of the present invention. The manner in which a user causes these actions by a mobile device, and any one of a number of methods for embodying these actions, are well known to those of ordinary skill in the art. Then, control is transferred to step 20.

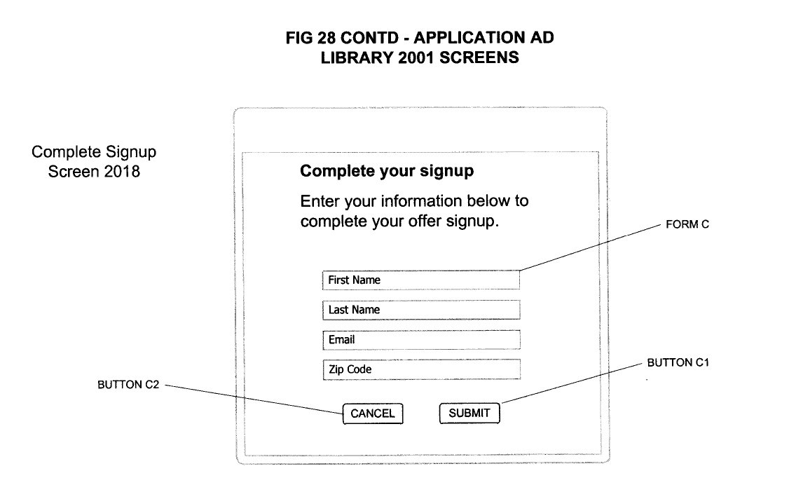

At step 20 shown in FIG. 21, the user causes the mobile device to execute the mobile app (the manner in which a user causes this action by a mobile device, and any one of a number of methods for embodying this action, are well known to those of ordinary skill in the art), and the Application Ad Library displays a registration screen that was created by an application Developer on a mobile device display, for example and without limitation, a touch screen display, as will be described below, in accordance with one or more embodiments of the present invention. Control is then transferred to step 30. FIG. 28 shows Registration Screen 2016 that is displayed on the user's mobile device by the Application Ad Library. In accordance with one or more embodiments, Registration Screen 2016 is configurable by the application Developer, and in particular, the Developer can choose which fields have data that is collected during a registration process.

As shown in FIG. 28, Registration Screen 2016 may include a Registration Offer Headline, Registration Offer creative material such as, for example and without limitation, an advertiser logo or other such information such as a trademark, and text which may be a message providing the user with a reason to sign up on the registration page. As further shown in FIG. 28, Registration Screen 2016 may include data capture fields for user registration, which data capture fields may include, for example and without limitation, name (for example, first name and last name), email address, and zip code. As further shown in FIG. 28, the Developer may also provide a method for the user to indicate s/he wishes to skip the registration screen. For example, the Developer may enable the user to skip registration by, for example and without limitation, clicking a “cancel” button using a mobile device user input device such as, for example and without limitation, a keyboard displayed on a touch screen or a keyboard input.

At step 30 shown in FIG. 21, the user clicks a button using the mobile device user input device, and control is transferred to decision step 35 shown in FIG. 21.

At decision step 35 shown in FIG. 21, the Application Ad Library determines whether the user clicked on cancel button A2 shown on Registration Screen 2016 in accordance with any one of a number of methods that are well known to those of ordinary skill in the art. If so, control is transferred to step 110 shown in FIG. 21, otherwise, control is transferred to step 40 shown in FIG. 21.

At step 40 shown in FIG. 21, the user enters data into the data capture fields shown on Registration Screen 2016 using the mobile device user input device, and clicks on submit button A1 shown on Registration Screen 2016 using the mobile device user input device. Control is then transferred to decision step 50 shown in FIG. 21.

At decision step 50 shown in FIG. 21, the Application Ad Library validates the data, i.e., it determines whether all the required information has been entered and whether the information entered is appropriate (for example, whether the zip code and email address conform to an appropriate formats and so forth). If more information is needed or if the entered information is not appropriate, control is transferred to step 60 shown in FIG. 21, otherwise, control is transferred to step 80 shown in FIG. 21. In addition, if the user does not complete the registration page, control is transferred to step 110 shown in FIG. 21. However, in this case, the registration page may be displayed again after a configurable number of executions of the app executions.

At step 60 shown in FIG. 21, the Application Ad Library prompts the user to correct invalid data by displaying a message on the mobile device display. Then, control is transferred to step 70 shown in FIG. 21.

At step 70 shown in FIG. 21, the user corrects the information on the registration screen and clicks the submit button, i.e., button A1 using the mobile device user input device. Then, control is transferred to step 50 shown in FIG. 21.

At step 80 shown in FIG. 21, the Application Ad Library stores the registration data, for example and without limitation, in encrypted form, inside the mobile application. Alternatively, the Application Ad Library transfers the registration data to the Ad Server. In addition, the Application Ad Library contacts the Ad Server, and in response, the Ad Server sends one or more advertisements, for example and without limitation, opt-in advertisements, from Advertiser(s), to the Application-Ad Library for display on the mobile device. Next, the Application Ad Library displays the one or more advertisements on the mobile device. The mobile ads may be displayed in a variety of sizes. For example and without limitation, in accordance with one or more embodiments of the present invention, ads would appear at the bottom of an app screen in a rectangle. In accordance with one or more further embodiments, ads would appear at the top of the app screen or ads may appear to take over the entire screen between app actions. As shown in FIG. 28, Ad Screen 2017 may include a number of offer blocks where an offer block may include (a) an offer headline; (b) offer creative material which, for example and without limitation, describes the Advertiser's product or service and invites the user to opt-in to the advertisement to receive more information on the product or service (this may also be referred to as an “opt-in offer”); and (c) a checkbox, a portion of a display where the user may (by appropriate input such as, for example and without limitation, by clicking on a box) indicate a desire to accept the opt-in offer (this “checkbox” may also be referred to as an “opt-in checkbox”). As further shown in FIG. 28, Ad Screen 2017 includes a cancel button B2 that the user may use to return the application screen real estate back to the mobile app and resume normal execution of the mobile app; and, in accordance with one or more further embodiments, Ad Screen 2017 includes a button, button B1, that the user may use to opt-into the ads. Next, control is transferred to step 90 shown in FIG. 21.

At step 90 shown in FIG. 21, the user may or may not click one or more offer opt-in checkboxes to opt-in to the advertisers' offers. Then, the user clicks submit button B1 to continue with the mobile app. Next, control is transferred to step 95 shown in FIG. 21.

At step 95 shown in FIG. 21, the Application Ad Library determines whether the user has opted-in to one or more advertisements. If, not, control is transferred to step 110 to resume normal execution of the app, otherwise control is transferred to step 100 shown in FIG. 21.

At step 100 shown in FIG. 21, the Application Ad Library sends user information from the registration process for the ads opted-in to Advertisers, for example, it sends the user information to a data bridge for transfer to Advertisers. Then, control is transferred to step 110 shown in FIG. 21.

At step 110 shown in FIG. 21, the mobile app resumes running.

In accordance with one or more further embodiments of the present invention, a registration page is not presented, only ads are presented to the user in the manner described above. In accordance with one or more such embodiments, the user may opt-in to one or more such ads, and when the user clicks the submit button, a “complete sign-up screen 2019 shown in FIG. 28. The user enters information and the information is checked as described above with respect to the registration page. Once again, the user may decide to cancel any opt-in by clicking the cancel button, button C2, or the user may decide to submit the sign-up. If the user has signed up, the Application Ad Library will send the user information for the ads opted-into to the Ad Server as described above, and the mobile app will resume.

Ad Server Computer System

In accordance with one or more embodiments of the present invention, an Ad Server computer system (also referred to herein as an Ad Server), for example and without limitation, a Pontiflex™ Ad Server computer system available from Pontiflex, Inc. of Brooklyn, N.Y., is a system that transmits advertisements from Advertisers in the form of various Ad Units to a mobile device for display thereon within a mobile app. In accordance with one or more such embodiments of the present invention, an Ad Unit displayed on the mobile device may include advertisements from one or more Advertisers at the same time, and software modules from an Application Ad Library running in the mobile app enable a user to opt-into one or more of the advertisements and to provide his/her personal information (for example and without limitation, name, email address and telephone number). In accordance with one or more such embodiments of the present invention, user interaction with an Ad Unit triggers code, for example and without limitation, BrowserScriptPost code (described below in the Appendix), that executes within the app, which code sends user data to Advertiser(s) via a data transfer system or data bridge such as, for example and without limitation, the Pontiflex™ data transfer system of computer system 1000 which is described below in the Appendix.

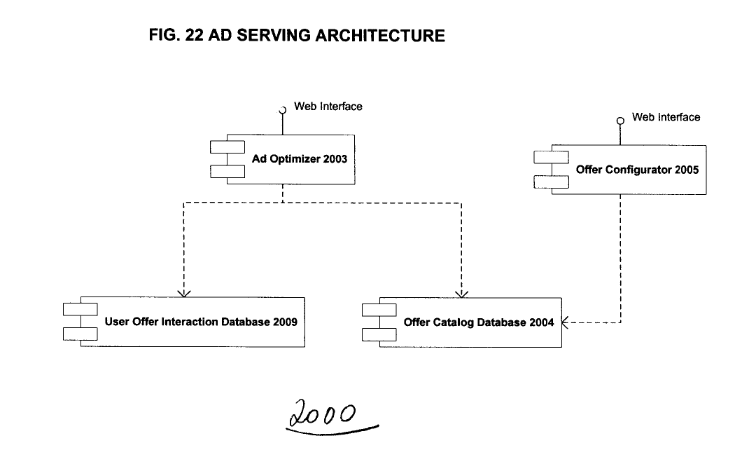

FIG. 22 is a block diagram of Ad Server computer system 2000 that is fabricated in accordance with one or more embodiments of the present invention. As shown in FIG. 22, in accordance with one or more embodiments of the present invention, Ad Server computer system 2000 comprises: (a) Ad Optimizer 2003, (b) Offer Catalog Database 2004, (c) Offer Configurator 2005; and (d) User Offer Interaction Database 2009. These modules of Ad Server computer system 2000 execute, for example and without limitation, on a computer system (for example and without limitation, a centralized computer system) that may be accessed/used by a number of Advertisers. As one of ordinary skill in the art can readily appreciate, Ad Optimizer 2003, Offer Catalog Database 2004, Offer Configurator 2005 and User Offer Interaction Database 2009 are combinations of software modules and computer hardware that provide functionality that will be described in detail below. In particular, computer system 2000 may include one or more computers, each of which includes computer hardware such as, for example and without limitation, one or more CPUs, memory (for example random access memory), data stores in the form of computer disks unit(s) and/or solid state storage, Internet interface equipment, communications interfaces, user interfaces such as user monitors and CRT displays or flat panel displays or touch screen displays and so forth, user input devices such as keyboards, and so forth. As one of ordinary skill in the art can readily appreciate, Ad Optimizer 2003, Offer Catalog Database 2004, Offer Configurator 2005 and User Offer Interaction Database 2009 may comprise software modules executing on the same computer or may comprise software modules executing on one or more different computers, and the data stores may utilize storage hardware associated with the same computer or one or more different computers.

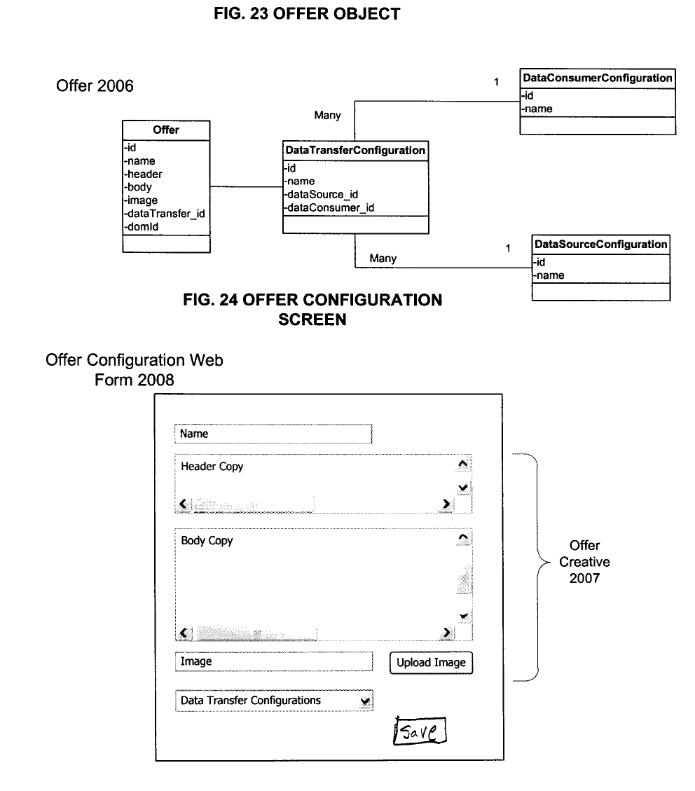

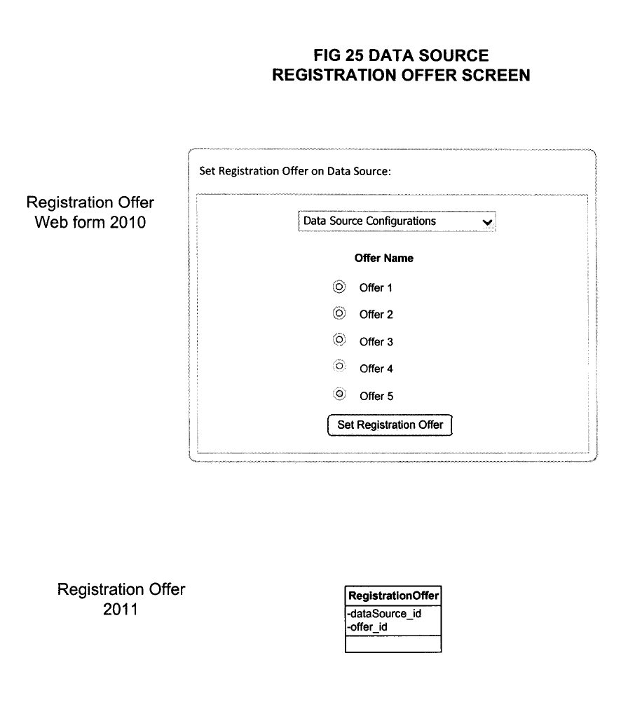

In accordance with one or more embodiments of the present invention, Offer Configurator 2005 shown in FIG. 22 is a module of Ad Server computer system 2000, and Offer Configurator 2005 provides a web interface that is used by an Advertiser to create an Offer object. In accordance with one or more such embodiments, the web interface provides Offer Configuration web form 2008 shown in FIG. 24 that has been fabricated in accordance with one or more embodiments of the present invention. As used herein, an Offer object is a singular instance of an advertisement that is created by an Advertiser to be run in a mobile app on a mobile device. FIG. 23 shows Offer object 2006 that has been fabricated in accordance with one or more embodiments of the present invention, and its relationship to a Data Transfer Configuration that is created by an Advertiser using the Pontiflex™ data transfer system (as described in the Appendix in conjunction with the Pontiflex application).

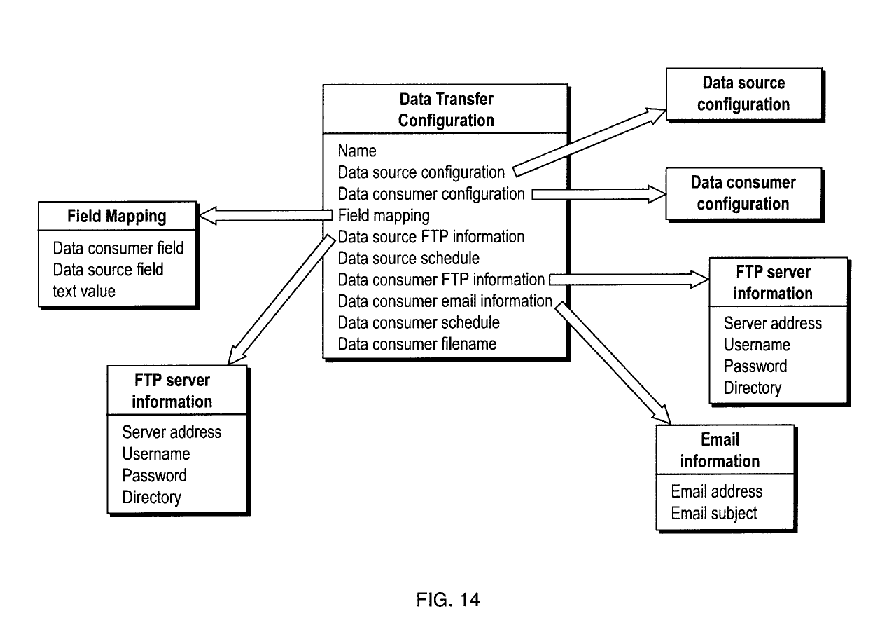

In accordance with one or more embodiments of the present invention, as shown in FIG. 23, Offer object 2006 typically includes various pieces of text that are collectively referred to as an “Offer Creative.” In accordance with one or more such embodiments, an Offer Creative may also include one or more image(s). Offer Creative 2007 of Offer Configuration web form 2008 shown in FIG. 24 comprises a portion of Offer Configuration web form 2008 used for entering the components of an Offer Creative. In accordance with one or more such embodiments of the present invention, Offer object 2006 also includes an id for a Data Transfer Configuration, i.e., “dataTransfer_id,” (Data Transfer Configuration is described in the Appendix in conjunction with FIG. 14, this is also FIG. 15 of the Pontiflex application) that was created previously by the Advertiser using the Pontiflex™ data transfer system of computer system 1000. The Data Transfer Configuration links: (a) an Advertiser's Data Consumer Configuration (described in the Appendix in conjunction with FIG. 13, this is also FIG. 14 of the Pontiflex application) with (b) a Publisher's Data Source Configuration (described in the Appendix in conjunction with FIG. 12, this is also FIG. 13 of the Pontiflex application). The Advertiser's Data Consumer Configuration is created by the Advertiser using a web interface of Advertiser Export Configurator 100 of the Pontiflex™ data transfer system of computer system 1000 (as described in the Appendix in conjunction with FIG. 1, this is also FIG. 1 of the Pontiflex application). The Publisher's Data Source Configuration is created by the Publisher using a web interface of Publisher Import Configurator 200 of the Pontiflex™ data transfer system of computer system 1000 (as described in the Appendix in conjunction with FIG. 1, this is also FIG. 1 of the Pontiflex application). The Data Transfer Configuration is created by the Advertiser using a web interface of Data Transfer Configurator 300 of the Pontiflex™ data transfer system of computer system 1000 (as described in the Appendix in conjunction with FIG. 1, this is also FIG. 1 of the Pontiflex application). As further described in the Appendix, the Data Source Configuration, the Data Consumer Configuration and the Data Transfer Configuration are stored in a configuration data store 250 of computer system 1000 (as described in the Appendix in conjunction with FIG. 1, this is also FIG. 1 of the Pontiflex application, which configuration data store 250 is accessible by Ad Server computer system 2000.

In accordance with one or more embodiments of the present invention, to create an Offer object using Offer Configuration web form 2008, an Advertiser: (a) enters a name for the Offer which is used by the Advertiser to identify the Advertising Offer (i.e., it is a human readable identifier of the Advertising Offer in Offer Catalog Database 2004—the name does not have to be unique in the database, it ought to be just different enough for the Advertiser to visually identify it from other offers the Advertiser has created); (b) enters Offer Creative—this typically includes text for a header, text for a body and an optional image; (c) selects one Data Transfer Configuration (stored in configuration data store 250) the Advertiser has created, for example, and without limitation, using a drop down menu. Next, Offer Configurator 2005 creates a numeric id (“id”) which may also serve as an identifier of Offer object 2006 in Offer Catalog Database 2004. Then, the Advertiser clicks on a Save button, at which instance, Offer Configurator 2005 creates and saves the new Offer object in Offer Catalog database 2004 shown in FIG. 22.

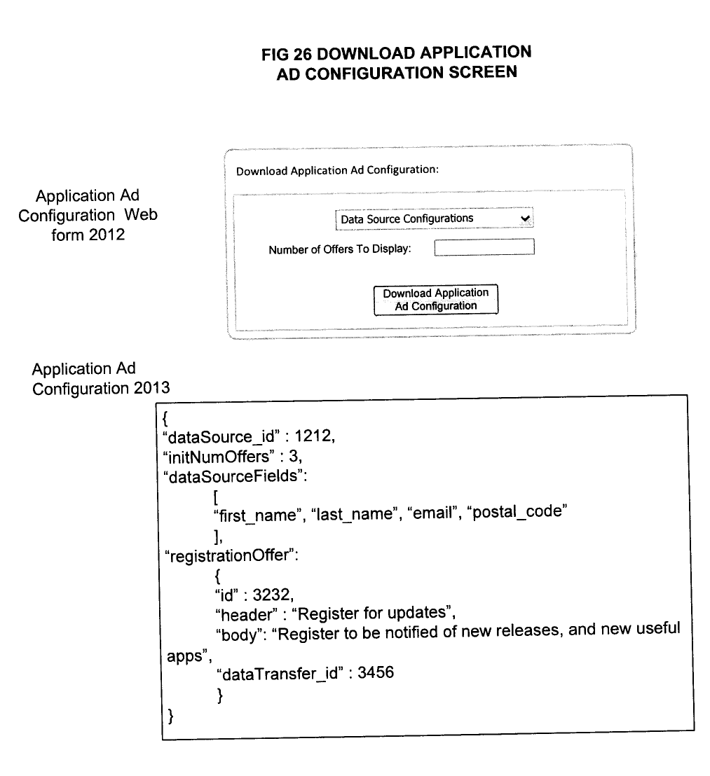

A Publisher and/or Developer (referred to here as Publisher/Developer) can create an offer for itself (thereby allowing users to register to the Publisher/Developer so the Publisher/Developer can see who is using the app by carrying out the following steps. Step 1, the Publisher/Developer accesses Data Export Configurator 100 of the Pontiflex™ data transfer system of computer system 1000 (as described in the Appendix in conjunction with FIG. 1, this is also FIG. 1 of the Pontiflex Application) which the Publisher/Developer uses to create a Data Consumer Configuration. Step 2, the Publisher/Developer creates a Data Transfer Configuration using a web interface of Data Transfer Configurator 300 of the Pontiflex™ data transfer system of computer system 1000 (as described in the Appendix in conjunction with FIG. 1, this is also FIG. 1 of the Pontiflex Application). To create the Data Transfer Configuration, the Publisher/Developer selects the Data Consumer Configuration created in Step 1 above, and selects one of its Data Source Configurations. Step 3, the Publisher/Developer creates an Offer object using Offer Configuration web form 2008, by: (a) entering a name for the Offer which is used by the Publisher/Developer to identify the Advertising Offer (i.e., it is a human readable identifier of the Advertising Offer in Offer Catalog Database 2004); (b) entering Offer Creative—this typically includes text for a header, text for a body and an optional image; and (c) selecting one Data Transfer Configuration created in Step 2 above. The Publisher/Developer then uses Registration Offer web form 2010 shown in FIG. 25 provided by Offer Configurator 2005 by a selecting the Data Source Configuration used while creating the Data Transfer Configuration in Step 2 above. Offer Configurator 2005 displays a list of all offers that are associated with Data Transfer Configurations which are associated with the selected Data Source Configuration. The Publisher/Developer then selects the Offer object created in Step 3 above, and clicks on the “Set Registration Offer” button in Registration Offer web form 2010. Offer Configurator 2005 then: (a) creates RegistrationOffer object 2011 (refer to FIG. 25) where: (i) the value of the key “offer_id” is set to the selected offer, and (ii) the value of the key “dataSource_id” is set to the Data Source Configuration selected in Step 2, and (b) saves the RegistrationOffer object in Offer Catalog Database 2004.

In accordance with one or more embodiments of the present invention, Ad Optimizer 2003 shown in FIG. 22 is a module of Ad Server computer system 2000, and Ad Optimizer 2003 provides a web interface that, upon request, returns a list of Offers from Offer Catalog database 2004 that a consumer is most likely to select (in light of the information and techniques used to provide the list) when presented to him/her in an Ad Unit. In accordance with one or more such embodiments, the list of Offers is returned in a format that can be read by Application Ad Library 2001, and in accordance with one or more such embodiments, the list is returned as a JSON formatted string, where JSON (JavaScript Object Notation) is a lightweight data-interchange format. JSON is based on a subset of the JavaScript Programming Language, Standard ECMA-262 3rd Edition—December 1999. A JSON formatted string is easy for humans to read and write, and is easy for machines to parse and generate. JSON is a text format that is language independent but uses conventions that are familiar to programmers of the C-family of languages, including C, C++, C#, Java, JavaScript, Perl, Python, and many others.

In accordance with one or more embodiments of the present invention, inputs (which inputs are provided as described in detail below) to a web interface provided by Ad Optimizer 2003 are: (a) an id of a Data Source Configuration; (b) a list of zero or more keywords (for example and without limitation, a list of plain text words separated by commas) which describe the application's content (for example, an app Developer might provide such a list of keywords); where such keywords help enable (as described below) the selection of relevant offers which are contextual to the application's content, and which offers therefore, might yield a higher response rate for an advertisement; (c) a unique mobile application installation identifier; (d) zero or more ids of Offers which represent a list of Offers a user had selected; and (e) an integer representing the number of Offers Ad Optimizer 2003 should return (i.e., a number of requested Offers). Then, in response, Ad Optimizer 2003 uses the id of the Data Source Configuration to determine an initial list of Offers that are present in Offer Catalog database 2004 which use a Data Transfer Configuration that uses the Data Source Configuration by querying Offer Catalog Database 2004 using a database query language such as, for example and without limitation, SQL. In accordance with one or more embodiments of the present invention, Ad Optimizer 2003 returns a list of the retrieved Offers (restricting the list to include no more than the number of requested Offers). In accordance with one or more alternative embodiments, Ad Optimizer 2003 filters the list of Offers down to a list of Offers that are more likely to be selected by users in an Ad Unit using commonly available techniques such as, for example and without limitation, Contextual Targeting, Behavioral Targeting or Collaborative Filtering. In accordance with one or more such alternative embodiments of the present invention, Ad Optimizer 2003 uses the list of keywords, if present, and applies Contextual Targeting techniques that are well known to those of ordinary skill in the art to determine which Offers are more likely to be selected by a user in the context of the application's content. In accordance with one or more further such alternative embodiments of the present invention, Ad Optimizer 2003 uses the optional, non-personally identifying mobile application installation identifier and applies Behavioral Targeting techniques that are well known to those of ordinary skill in the art to determine automatically which Offers are more likely to be selected by a user based on his/her previous interactions (i.e., selected previously) with other Offers in accordance with any one of a number of commonly available embodiments of Behavioral Targeting techniques. In accordance with one or more still further such alternative embodiments of the present invention, Ad Optimizer 2003 applies Collaborative Filtering techniques that are well known to those of ordinary skill in the art to determine automatically which Offers are more likely to be selected in the context of the Offers which have been already selected by the user in accordance with any number of commonly available embodiments of collaborative filtering techniques. In accordance with one or more embodiments of the present invention, data relating to Offers selected by a user were transmitted by AdManager 2014 (to be described in detail below) to Ad Optimizer 2003, and Ad Optimizer 2003 stored the data in User Offer Interaction Database 2009 of Ad Server system 2000 (refer to FIG. 22).

Application Ad Library 2001

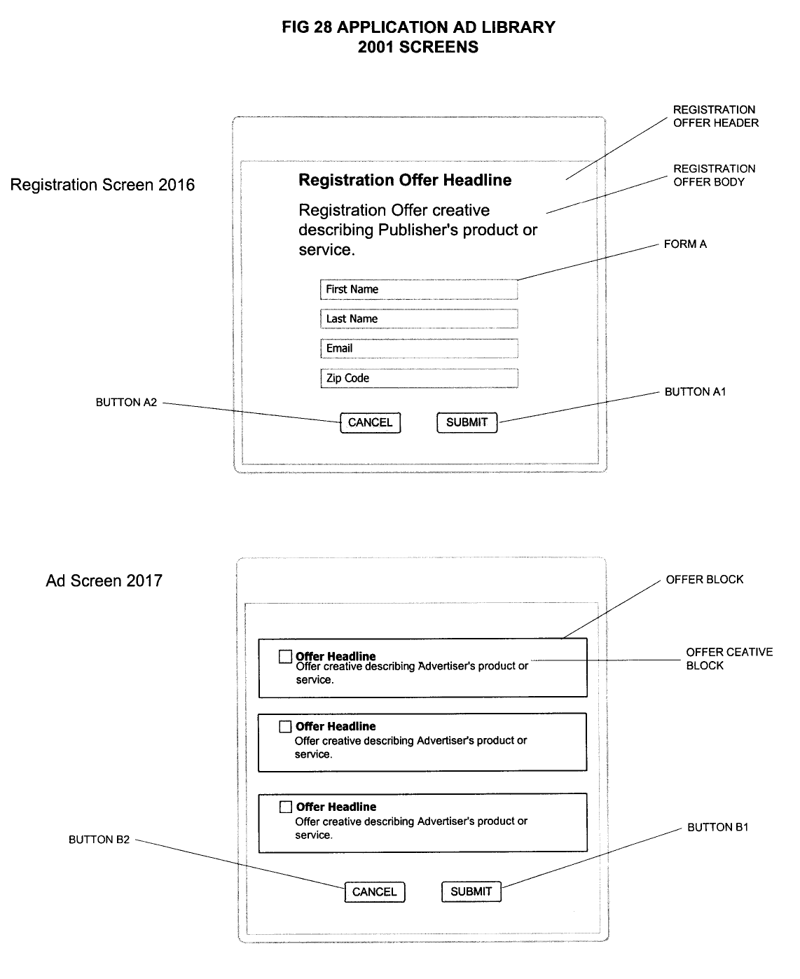

In accordance with one or more embodiments of the present invention, Application Ad Library 2001 shown in FIG. 27 is provided as an Application Programming Environment compatible SDK (“System Development Kit”) to a Developer. In accordance with one or more such embodiments, Application Ad Library 2001 may be provided, for example and without limitation, as a JAR file for Android, as an Application Bundle for OSX/iOS, as a DLL or .NET Assembly for WindowsXPNista/7, or as a Silverlight Assembly for Windows Phone 7. In accordance with one or more such embodiments of the present invention, the Developer packages the Application Ad Library 2001 inside his/her application using a standard Application Programming Environment procedure such as, for example and without limitation, by copying the JAR file into the “assets” folder for an Android Application or by copying the Application Bundle into the iOS XCode project of an iOS Application.

In accordance with one or more embodiments, Application Ad Library 2001 contains AdManager 2014 (refer to FIG. 27), and it utilizes an Application Operating System provided Application Secure Data Store 2015 (refer to FIG. 27). Typical examples of Application Secure Data Store 2015 are Keystores in Android, Keychain in OSX/iOS, Silverlight Isolated Storage in Windows Phone 7, and Secure Registry Keys for WindowsXPNista/7. In accordance with one or more such embodiments, Application Secure Data Store 2015 provides an encrypted storage space that is isolated to the Application Scope, i.e. another application installed on the same mobile device cannot access or read the contents of Application Secure Store 2015, and only the Application is able to add/update contents of Application Secure Data Store 2015. Application Secure Data Store 2015, across all Operating Systems, can be abstracted (i.e., thought of) as a key-to-value map type storage.

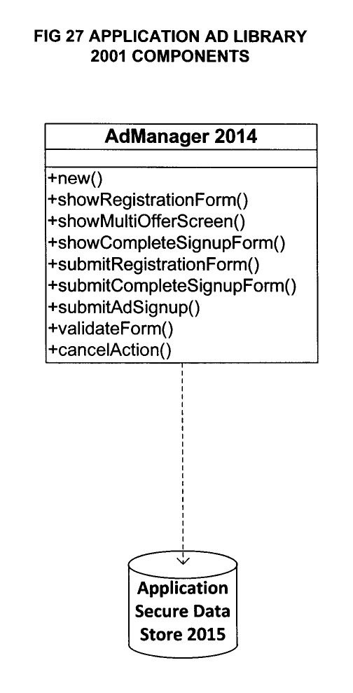

To configure an Ad Unit, a Developer uses Offer Configurator 2005 of Ad Server computer system 2000 to obtain Application Ad Configuration web form 2012 that is fabricated in accordance with one or more embodiments, an embodiment of Application Ad Configuration Web Form 2012 is shown in FIG. 26. Next, using Application Ad Configuration Web Form 2012, the Developer: (a) selects a Data Source Configuration; (b) enters the number of advertiser offers to display to the user; and (b) clicks on the “Download Application Ad Configuration Screen.” In response, Offer Configurator 2005 of Ad Server computer system 2000 creates Application Ad Configuration 2013 that is fabricated in accordance with one or more embodiments, an embodiment of Application Ad Configuration web form 2012 is shown in FIG. 26. In accordance with one or more such embodiments, Application Ad Configuration 2013 is generated in JSON format by: (a) setting the value of the key “dataSource_id” to the id of the Data Source Configuration selected in Application Ad Configuration Web Form 2012; (b) setting the value of the key “initNumOffers” to the value entered for the “Number of Offers To Display” in Application Ad Configuration Web Form 2012; (c) setting the array “dataSourceFields” to an array consisting of the names of the fields contained in the Data Source Configuration; and (d) if there is to be a registration offer, setting the value of the key “registrationOffer” to the Registration Offer selected for the Data Source Configuration by the Publisher/Developer using Registration Offer Web Form 2010. Then, Application Ad Configuration 2013 is provided to the Developer, for example and without limitation, as a downloaded file.

In accordance with one or more such embodiments, the Developer then packages Application Ad Configuration 2013 inside the desired app using Application Programming Environment packaging mechanisms that are well known to those of ordinary skill in the art so that Application Ad Configuration 2013 is packaged, for example and without limitation, in the “assets” folder of an Android Application, in the “Resources” folder of an iOS Application, and so forth.

As one of ordinary skill in the art can readily appreciate, the AdManager component (for example, AdManager 2014 shown in FIG. 27) of the Application Ad Library (for example, Application Ad Library 2001 shown in FIG. 27) is used to provide the user experience in terms of presenting and interacting with advertising on his/her mobile device within a mobile app. As such, the experience can be changed in accordance with the desire of the Developer by using the Application Ad Library SDK to change the AdManager component, for example by rearranging the order in which routines are called, by adding new routines or by omitting routines.

Operational Mode 1: Show Registration Screen followed by Ad Screen

To effectuate an operational mode (Operational Mode 1) where a Registration Screen is displayed, followed by an Ad Screen, the Developer creates a new instance of AdManager 2014 (refer to FIG. 27) by invoking the “new” method of the mobile device operating systems on AdManager 2014 in his/her Application Code. The Application Code then invokes the function showRegistrationForm( ) of AdManager 2014, typically this is done immediately after the Application is launched.

In accordance with one or more embodiments of the present invention, function showRegistrationForm( ) checks if Application Secure Data Store 2015 contains data object 901 (described in the Appendix). If Application Secure Data Store 2015 contains data object 901, showRegistrationForm( ) invokes the function showMultiOfferScreen( ) of AdManager 2014, and function showRegistrationForm( ) exits. If Application Secure Data Store 2015 does not contain data object 901, function showRegistrationForm( ) draws Registration Screen 2016 (refer to FIG. 28)—Registration Screen 2016 is fabricated in accordance with one or more embodiments of the present invention—using native screen elements provided by the Application Programming Environment in accordance with any one of a number of methods that are well known to those of ordinary skill in the art. In particular, showRegistrationForm( ) reads Application Ad Configuration 2013 (refer to FIG. 26). Then, showRegistrationForm( ) creates a native text element “Registration Offer Headline,” and sets its value to the “header” value of the “registrationOffer” element in Application Ad Configuration 2013. Next, showRegistrationForm( ) creates a text element “Registration Offer Body,” and sets its value to the “body” value of the “registrationOffer” element in Application Ad Configuration 2013. Next, function showRegistrationForm( ) creates “Form A” shown in FIG. 28 by creating native input text boxes for each of the fields listed in “dataSourceFields” in Application Ad Configuration 2013. Next, showRegistrationForm( ) creates “Button A 1” shown in FIG. 28, and sets the onclick event for Button A1 to invoke function submitRegistrationForm( ) of AdManager 2014. Next, showRegistrationForm( ) creates “Button A2” shown in FIG. 28, and sets the onclick event for Button A2 to invoke function cancelAction( ) of AdManager 2014. Function showRegistrationForm( ) also stores the value of the “id” and “dataTransfer_id” of the “registrationOffer” element in Application Ad Configuration 2013 in the “view state storage” of Registration Screen 2016. As is well known, “view state storage” is storage provided by the Application Programming Environment that a screen can use to store its state during an instantiation of the screen's being visible to the user and the user's subsequent interaction with the screen. The “view state storage” is erased between separate invocations of the screen so that data stored in the “view state storage” is not persisted between invocations. In accordance with one or more embodiments of the present invention, if a user clicks on “Button A2,” Registration Screen 2016 invokes the function cancelAction( ) of AdManager 2014, and function cancelAction( ) closes and removes Registration Screen 2016.

In accordance with one or more embodiments of the present invention, if a user clicks on “Button A1,” Registration Screen 2016 invokes function submitRegistrationForm( ) of AdManager 2014. In accordance with one or more such embodiments, function submitRegistrationForm( ) executes the following steps. Function submitRegistrationForm( ) executes function validateForm( ) of AdManager 2014 which executes the following steps. Function validateForm( ) checks whether the user has entered information for all input fields inside form “FormA.” In addition, if the input fields inside form “FormA” include an Email field, function validateForm( ) of AdManager 2014 verifies that the value conforms to a valid “Email” syntax. In further addition, if the Developer chooses to restrict users to be residents of a particular country, and the input fields inside form “FormA” include a Postal Code field (for example, Zip Code in the United States), function validateForm( ) of AdManager 2014 verifies that the value conforms to a valid “PostalCode” syntax for that country. An example of this would be to check whether the “PostalCode” value is a five (5) digit number if the country is the United States. If these checks do not pass, a native “alert” notification box is called with a message informing the user that he/she has to correct a corresponding input field, and function validateForm( ) of AdManager 2014 returns “false.” If all checks pass, function validateForm( ) of AdManager 2014 returns “true.”

Next, function submitRegistrationForm( ) of AdManager 2014 checks the return value of function validateForm( ) of AdManager 2014. If the return value of function validateForm( ) of AdManager 2014 is “false,” function submitRegistrationForm( ) of AdManager 2014 exits. If the return value of function validateForm( ) of AdManager 2014 is “true,” the process continues with the following steps.

In accordance with one or more embodiments of the present invention, function submitRegistrationForm( ) of AdManager 2014 creates an instance of data object 901 (refer to the Appendix and the Pontiflex Application). Next, function submitRegistrationForm( ) of Ad Manager 2014 obtains a list of all input elements inside form “FormA” in accordance with one or more methods that are well known to those of ordinary skill in the art. Next, for each of the input elements, function submitRegistrationForm( ) of AdManager 2014 adds a key and value pair in data object 901 (the key is the “id” key of the input element and the value is the “value” of the input element). Next, function submitRegistrationForm( ) of AdManager 2014 constructs and adds a request for an image file from computer system moo (refer to the Pontiflex application). The request for the image file is constructed as an HTTP GET request with the key and value pairs in data object 901 added in as parameters of the HTTP GET request. In addition, the key “dataTransfer_id” of the “registrationOffer” element in Application Ad Configuration 2013 is also added as a parameter of the HTTP GET request. The user data provided by the user's interacting with Registration Screen 2016 is thus collected and passed to computer system 1000 for onward transfer by computer system 1000 to the data consumer created by the Publisher/Developer specified in the data transfer configuration corresponding to the value of the key “dataSource_id” of Registration Offer 2011 (refer to FIG. 25).

Next, function submitRegistrationForm( ) stores data object 901 in Application Secure Data Store 2015. Next, function submitRegistrationForm( ) calls function showMultiOfferScreen( ) of Ad Manager 2014 and exits.

In accordance with one or more embodiments of the present invention, function showMultiOfferScreen( ) calls Ad Optimizer 2003 of Ad Server computer system 2000 through its web interface (refer to FIG. 22), and passes: (a) the value of the key “dataSource_id” in Application Ad Configuration 2013 (refer to FIG. 26) as the id of the Data Source Configuration; (b) a list of keywords representing the Application content, if available; and (c) the value of the key “initNumOffers” in Application Ad Configuration 2013 (refer to FIG. 26) as the number of offers to fetch. In response, and as described above, Ad Optimizer 2003 provides a list of Advertiser Offers in, for example and without limitation, JSON format, which list is received by function showMultiOfferScreen( ) Next, function showMultiOfferScreen( ) creates Ad Screen 2017 (refer to FIG. 28) that is fabricated in accordance with one or more embodiments of the present invention. For each Offer object in the list of Advertiser Offers received from Ad Optimizer 2003, showMultiOfferScreen( ) creates the “Offer Block” by creating a native text element and setting its value to the “header” value of the Offer object. Next, function showMultiOfferScreen( ) creates another native text element and sets its value to the “body” value of the Offer object. Next, function showMultiOfferScreen( ) creates a native checkbox element with the checkbox set to unselected state. Next, function showMutiOfferScreen( ) creates native button element “Button B1,” and sets the onclick event of Button B1 to invoke function submitAdSignup( ) of AdManager 2014. Next, function showMultiOfferScreen( ) creates another native button element, “Button B2,” and sets the onclick event of Button B2 to invoke function cancelAction( ) of AdManager 2014. If the user clicks on “Button B2,” Ad Screen 2017 invokes function cancelAction( ) of AdManager 2014. In response, function cancelAction( ) closes and removes Ad Screen 2017.

If the user selects one or more offers and clicks on “Button B1,” Ad Screen 2017 invokes function submitAdSignup( ) of AdManager 2014. In response, function submitAdSignup( ) checks if Application Secure Data Store 2015 contains data object 901.

If Application Secure Data Store 2015 contains data object 901, then for each checkbox in Ad Screen 2017, function submitAdSignup( ) checks if the user selected that checkbox. If a checkbox was selected, function submitAdSignup( ) constructs and adds a request for an image file from computer system 1000 (refer to the Pontiflex application). The request for the image file resource is constructed as an HTTP GET request with the key and value pairs in data object 901 added in as parameters of the HTTP GET request. The value of the key “dataTransfer_id” of the Offer object corresponding to the selected checkbox is also added as a parameter to the HTTP GET request. Finally, function submitAdSignup( ) closes and removes Ad Screen 2017.

If Application Secure Data Store 2015 does not contain data object 901, function submitAdSignup( ) creates a new array selectedOffers in application memory to store offers selected in Ad Screen 2017. Next, function submitAdSignup( ) executes the following for each checkbox in Ad Screen 2017. Function submitAdSignup( ) checks if the user selected the checkbox. If the checkbox was selected, the Offer object corresponding to the selected checkbox is added to selectedOffers array. Next, function submitAdSignup( ) invokes function showCompleteSignupForm( ) of AdManager 2014, next, function submitAdSignup( ) closes and removes Ad Screen 2017, and exits. In Operational Mode 1, since Ad Screen 2017 is immediately displayed after Registration Screen 2016, and Registration Screen 2016 ensures that Application Secure Data Store 2015 will contain data object 901, function submitAdSignup( ) does not have to go through the operations described in this paragraph in Operational Mode 2.

Operational Mode 2: Ad Screen followed by “Complete Sign-up” Screen

To effectuate an operational mode (Operational Mode 2) where an Ad Screen is displayed, followed by a “Complete Sign-up” Screen, the Developer creates a new instance of AdManager 2014 (refer to FIG. 27) by invoking the “new” method on AdManager 2014 in his/her Application Code. The Application Code then invokes the function showMultiOfferScreen( ) of AdManager 2014, typically immediately after the Application is launched.

In accordance with one or more embodiments of the present invention, function showMultiOfferScreen( ) calls Ad Optimizer 2003 of Ad Server computer system 2000 through its web interface (refer to FIG. 22) and passes: (a) the value of the key “dataSource_id” in Application Ad Configuration 2013 (refer to FIG. 26) as the id of the Data Source Configuration; (b) a list of keywords representing the Application content, if available; and (c) the value of the key “initNumOffers” in Application Ad Configuration 2013 (refer to FIG. 26) as the number of offers to fetch. In response, as described above, Ad Optimizer 2003 provides a list of Advertiser Offers in, for example and without limitation, JSON format, which list is received by function showMultiOfferScreen( ) Next, function showMultiOfferScreen( ) creates Ad Screen 2017 (refer to FIG. 28) that is fabricated in accordance with one or more embodiments of the present invention. For each Offer object in the list of Advertiser Offers received from Ad Optimizer 2003, showMultiOfferScreen( ) creates the “Offer Block” by creating a native text element and setting its value to the “header” value of the Offer object. Next, function showMultiOfferScreen( ) creates another native text element and sets its value to the “body” value of the Offer object. Next, function showMultiOfferScreen( ) creates a native checkbox element with the checkbox set to unselected state. Next, function showMutiOfferScreen( ) creates native button element “Button B1,” and sets the onclick event of Button B1 to invoke function submitAdSignup( ) of AdManager 2014. Next, function showMultiOfferScreen( ) creates another native button element, “Button B2,” and sets the onclick event of Button B2 to invoke function cancelAction( ) of AdManager 2014. If the user clicks on “Button B2,” Ad Screen 2017 invokes function cancelAction( ) of AdManager 2014. In response, function cancelAction( ) closes and removes Ad Screen 2017.

If the user selects one or more offers and clicks on “Button B1,” Ad Screen 2017 invokes function submitAdSignup( ) function of AdManager 2014. In response, function submitAdSignup( ) checks if Application Secure Data Store 2015 contains data object 901.

If Application Secure Data Store 2015 contains data object 901, then for each checkbox in Ad Screen 2017, function submitAdSignup( ) checks if the user selected that checkbox. If the checkbox was selected, function submitAdSignup( ) constructs and adds a request for an image file from computer system 1000 (refer to the Pontiflex application). The request for the image file resource is constructed as an HTTP GET request with the key and value pairs in data object 901 added in as parameters of the HTTP GET request. The value of the key “dataTransfer_id” of the Offer object corresponding to the selected checkbox is also added as a parameter to the HTTP GET request. Finally, function submitAdSignup( ) closes and removes Ad Screen 2017.

If Application Secure Data Store 2015 does not contain data object 901, function submitAdSignup( ) creates a new array selectedOffers in application memory to store offers selected in Ad Screen 2017. Next, function submitAdSignup( ) executes the following for each checkbox in Ad Screen 2017. Function submitAdSignup( ) checks if the user selected the checkbox. If the checkbox was selected, the Offer object corresponding to the selected checkbox is added to selectedOffers array. Next, function submitAdSignup( ) invokes function showCompleteSignupForm( ) of AdManager 2014, next, function showCompleteSignupForm( ) closes and removes Ad Screen 2017, and exits.

Next, function showCompleteSignupForm( ) draws Complete Signup Screen 2018 (refer to FIG. 28)—Complete Signup Screen 2018 is fabricated in accordance with one or more embodiments of the present invention using native screen elements provided by the Application Programming Environment in accordance with any one of a number of methods that are well known to those of ordinary skill in the art. In particular, function showCompleteSignupForm( ) reads Application Ad Configuration 2013 (refer to FIG. 26). Then, function showCompleteSignupForm( ) creates a native text element “Complete Signup Offer Header” and sets its value to the text “Complete your signup.” Next, function showCompleteSignupForm( ) creates a text element “Complete Signup Offer Body,” and sets its value to the text “Enter your information below to complete your signup.” Next, function showCompleteSignupForm( ) creates “Form C” shown in FIG. 28 by creating native input text boxes for each of the fields listed in “dataSourceFields” in Application Ad Configuration 2013. Next, function showCompleteSignupForm( ) creates “Button C1” shown in FIG. 28, and sets the onclick event for Button C1 to invoke function submitCompleteSignupForm( ) of AdManager 2014. Next, function showCompleteSignupForm( ) creates “Button C2” shown in FIG. 28, and sets the onclick event for Button C2 to invoke function cancelAction( ) of AdManager 2014. In accordance with one or more embodiments of the present invention, if a user clicks on “Button A2,” Complete Signup Screen 2018 invokes the function cancelAction( ) of AdManager 2014, and function cancelAction( ) close and removes Complete Signup Screen 2018.

In accordance with one or more embodiments of the present invention, if a user clicks on “Button C1,” Complete Signup Screen 2018 invokes function submitCompleteSignupForm( ) of AdManager 2014. In accordance with one or more such embodiments, function submitCompleteSignupForm( ) executes the following steps. Function submitCompleteSignupForm( ) executes function validateForm( ) of AdManager 2014 which executes the following steps. Function validateForm( ) checks whether the user has entered information for all input fields inside form “FormC”. In addition, if the input fields inside form “FormC” include an Email field, function validateForm( ) of Ad Manager 2014 verifies that the value conforms to a valid “Email” syntax. In further addition, if the Developer chooses to restrict users to be residents of a particular country, and the input fields inside form “FormC” include a Postal Code field (for example, Zip Code in the United States), function validateForm( ) of AdManager 2014 verifies that the value conforms to a valid “PostalCode” syntax for that country. An example of this would be to check whether the “PostalCode” value is a five (5) digit number if the country is the United States. If these checks do not pass, a native “alert” notification box is called with a message informing the user that he/she has to correct a corresponding input field, and the function validateForm( ) of AdManager 2014 returns “false.” If all checks pass, function validateForm( ) of AdManager 2014 returns “true.”

Next, function submitCompleteSignupForm( ) of AdManager 2014 checks the return value of function validateForm( ) of AdManager 2014. If the return value of function validateForm( ) of AdManager 2014 is “false,” function submitCompleteSignupForm( ) of AdManager 2014 exits. If the return value of function validateForm( ) of AdManager 2014 is “true,” the process continues with the following steps.

For each Offer object in selectedOffers array (created by submitAdSignup function when Application Secure Data Store 2015 does not contain data object 901), function submitCompleteSignupForm( ) constructs and adds a request for an image file from computer system 1000 (refer to the Pontiflex application). The request for the image file is constructed as an HTTP GET request with the key and value pairs in data object 901 added in as parameters of the HTTP GET request. In addition, the value of the key “dataTransfer_id” of the Offer object is also added as a parameter of the HTTP GET request. Next, function submitCompleteSignupForm( ) closes and removes Complete Signup Screen Screen 2018.

Embodiments of the present invention described above are exemplary. As such, many changes and modifications may be made to the description set forth above by those of ordinary skill in the art while remaining within the scope of the invention. As such, the scope of the invention should be determined with reference to the appended claims along with their full scope of equivalents.

### APPENDIX

### The Pontiflex™ Data Transfer System

One or more embodiments of the present invention utilize a computer system that provides a data bridge connecting Publishers (a Publisher is also referred to herein as a “data source” and may include a computer system or a mobile device), for example and without limitation, online Publishers, to Advertisers (an Advertiser is also referred to herein as a “data consumer” and may include a computer system referred to as an Advertiser computer system or as an Advertiser), for example and without limitation, online Advertisers, to transfer data between them. In particular, in accordance with one or more such embodiments, the computer system mediates data transfers so that data sources can connect to the computer system (i.e., the data bridge system) in their preferred data transfer protocols to send data, and data consumers can build their connections to the computer system (i.e., the data bridge system) in their preferred data transfer protocols to receive the data. As such, in accordance with one or more such embodiments, by converting data received from data sources into data sent to data consumers, the computer system (i.e., the data bridge system) can provide: (a) a flexible data bridge that enables simple connectivity between parties; (b) immediate delivery of customer data and lowered cost of doing business; and (c) greater value for data being transferred. As will be described below, the computer system integrates online data transfers (typically comprised of data provided by customers such as, for example and without limitation, name, email address, zip code, credit card number, or other information) between Publishers and Advertisers using a set up process. Once the set up process is complete, the computer system (i.e., the data bridge system) can translate data received from a Publisher (i.e., a data source or Publisher computer system) and send the data to an Advertiser (i.e., a data consumer or Advertiser computer system) by automatically recognizing the data output format provided by the Publisher and converting that information into the data input format required by the Advertiser. In addition, the computer system (i.e., the data bridge system) can archive the data for backup purposes, and all transfer statistics and metrics can be viewed by consumers via a web interface. In accordance with one or more such embodiments, the computer system (i.e., the data bridge system) and its method of operation can enable (and advantageously can simplify) data transfer between data sources and data consumers via, for example and without limitation, open data transfer protocols. In accordance with one or more such embodiments, the data transferred may be in the form of a data structure, for example and without limitation, a data structure in tabular form consisting of one or more rows, with each row consisting of one or more columns (fields). In accordance with one or more such embodiments, the computer system (i.e., the data bridge system) can automatically guess and map each Advertiser data field to a Publisher data field using string matching algorithms to compare and match data field names. Advantageously, this enables Publishers and Advertisers to skip an intermediate step of manually matching and connecting Advertiser and Publisher lists of fields, and reduces the number of steps to set up a data transfer in the computer system (i.e., the data bridge system). In accordance with one or embodiments, the computer system (i.e., the data bridge system) and its described method of operation can provide the following capabilities: (a) a web-enabled interface (for example and without limitation, a form) for use by consumers to sign up for services rendered by the computer system (i.e., the data bridge system); (b) a web-enabled interface (for example and without limitation, a form) to set up data source configurations that specify (i) data transfer protocols used to transfer data from a data source to the computer system (i.e., the data bridge system), and (ii) data fields that make up each record of data received from the data source; (c) a web-enabled interface (for example and without limitation, a form) to set up data consumer configurations that specify (i) data transfer protocols used to transfer data from the computer system (i.e., the data bridge system) to a data consumer, and (ii) data transfer fields that make up each record of data to be sent to the data consumer; and (d) a web-enabled interface (for example and without limitation, a form) to set up data transfer configurations that specify (i) whether the computer system (i.e., the data bridge system) will pull data from a data source or the data source will push data to the computer system (i.e., the data bridge system), (ii) where the data source will push data to the computer system (i.e., the data bridge system), the computer system (i.e., the data bridge system) will create a data storage area for the data transfer, and, if required by the data transfer protocol (specified in the data source configuration), will generate credentials to access the data storage area, (iii) where the computer system (i.e., the data bridge system) will pull data from the data source, the data store information and credentials required by the computer system (i.e., the data bridge system) to access a data store created by the data source, (iv) whether the computer system (i.e., the data bridge system) will push data to a data consumer or the data consumer will pull the data from computer system (i.e., the data bridge system), (v) where the data consumer will pull data from the computer system (i.e., the data bridge system), the computer system (i.e., the data bridge system) will create a data storage area for the data transfer, and if required by the data transfer protocol (as specified in data consumer configuration), generate credentials to access the data storage area, (vi) where the computer system (i.e., the data bridge system) will push data to the data consumer, the data store information and credentials required by the computer system (i.e., the data bridge system) to access the data storage area created by the data consumer, and (vii) the computer system (i.e., the data bridge system) will automatically match the list data fields to be sent to the data consumer to the list of data fields received from the data source and will provide a web-based form to have the consumer verify and manually correct any mismatches between the two sets of data fields. In particular, one embodiment is a data bridge between Publishers and Advertisers for sending data from a Publisher to an Advertiser, which data bridge comprises: a computer system, which computer system includes: (a) a data consumer configurator; (b) a data source configurator; (c) a configuration data store; (d) a data transfer configurator; (e) a data transfer scheduler; (f) a data transfer engine; (g) a primary data store; (h) a tracking and billing component; and (i) an archiver.

FIG. 1 is a block diagram of a system architecture of computer system 1000. As shown in FIG. 1, computer system 1000 comprises data consumer (or Advertiser export) configurator 100, data source (or Publisher import) configurator 200, configuration data store 250, data transfer configurator 300, data transfer scheduler 400, data transfer engine 500, primary (or main lead) data store 600, tracking and billing component 700, and archiver 800. As one of ordinary skill in the art can readily appreciate, data consumer configurator 100, data source configurator 200, configuration data store 250, data transfer configurator 300, data transfer scheduler 400, data transfer engine 500, primary data store 600, tracking and billing component 700, and archiver 800 are combinations of software modules and computer hardware that provide functionality that will be described in detail below. In particular, computer system 1000 may include one or more computers, each of which includes computer hardware such as, for example and without limitation, one or more CPUs, computer memory (for example random access memory), data stores in the form of computer disks unit(s) and/or solid state storage, Internet interface equipment, communications interfaces, user interfaces such as user monitors and CRT displays or flat panel displays or touch screen displays and so forth, user input devices such as keyboards, and so forth. As one of ordinary skill in the art can readily appreciate, data consumer configurator 100, data source configurator 200, configuration data store 250, data transfer configurator 300, data transfer scheduler 400, data transfer engine 500, primary data store 600, tracking and billing component 700, and archiver 800 may comprise software modules executing on the same computer or may comprise software modules executing on one or more different computers, and the data stores may utilize storage hardware associated with the same computer or one or more different computers. Certain parts of the description below refer to a data source and a data consumer having web access to computer system 1000. In accordance with one or more embodiments, this is done by a data source and a data consumer first going to a website of a company (for example, Pontiflex, Inc.) running computer system 1000 and registering for an account. Registration may be done, for example and without limitation, by providing registration credentials such as, for example and without limitation, a name, email address, mailing address, and perhaps other contact information. The registration credentials are reviewed by the company (for example, Pontiflex, Inc.) staff, and, provided they are judged to be valid in accordance with company criteria, the company staff creates an account for the consumer and sends login credentials (for example, consumer ID and password) to the consumer via email or telephone. Consumers then can go to the company's website and click a “Log In” button and use these credentials to log in to computer system 1000. In accordance with one or more further embodiments, consumers can create their own accounts without prior approval by company staff. In accordance with one or more such embodiments, upon submitting their credentials, computer system 1000 automatically creates and presents a password and consumer name for the registrant after they register. However, in either case, company staff have an option to disable a consumer account of consumer immediately via computer system 1000.

Data Consumer Section

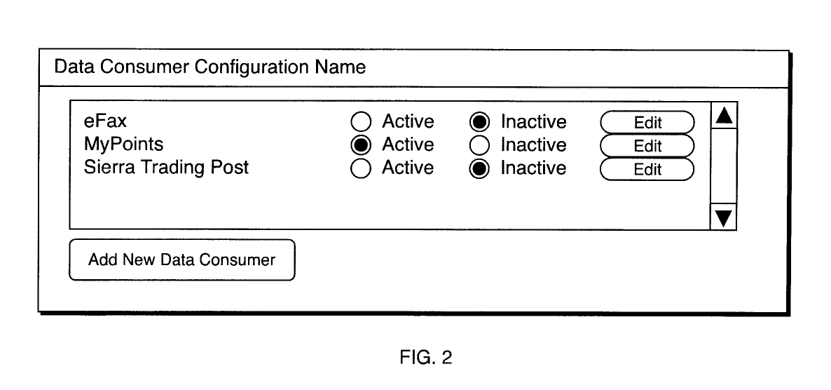

FIGS. 2-4 show screens used to describe data consumer configurator 100 that is fabricated in accordance with one or more embodiments to help one of ordinary skill in the art understand how to make and use computer system 1000. In accordance with one or more embodiments, data consumer configurator 100 is a module of computer system 1000 that exposes an interface, for example and without limitation, a web interface, in accordance with any one of a number of methods that are well known to those of ordinary skill in the art, wherein a data consumer can specify parameters required to receive data from computer system 1000. In accordance with one or more embodiments, the data consumer uses the interface as a set up tool, for example and without limitation, as a one-time set up tool, to specify configuration data (also referred to herein as a “configuration”) relating, among other things, to how computer system 1000 will send data to the data consumer. In accordance with one or more embodiments, the data consumer will need to change its configuration data only if it makes changes, for example and without limitation, in the way it wants or needs to receive data from computer system 1000. In addition, in accordance with one or more embodiments, a data consumer, if it chooses, can specify multiple configurations, for example and without limitation, one configuration for each different method of receiving data from computer system 1000. As will be described in detail below, the interface will provide web pages: (a) listing all existing configurations; (b) listing options to edit existing configurations; and (c) enabling addition of new configurations.

For a data consumer to initiate a new data consumer configuration or to edit an existing one, the data consumer accesses a web interface exposed by data consumer configurator 100 by clicking on a link to the web interface in a browser. In response, data consumer configurator 100 queries configuration data store 250 to retrieve all existing data consumer configurations set up by the data consumer previously (in accordance with any one of a number of methods that are well known to those of ordinary skill in the art), and data consumer configurator 100 displays this data as a list in the screen shown in FIG. 2 (in accordance with any one of a number of methods that are well known to those of ordinary skill in the art). As shown in the screen shown in FIG. 2, and in accordance with one or more embodiments, each data consumer configuration has a name, and a flag (“Active” or “Inactive”) used to indicate to data transfer engine 500 that the data consumer will accept data according to the format and method specified by this data consumer configuration. In addition, as shown in the screen shown in FIG. 2, an “Edit” button is displayed next to each data consumer configuration (in accordance with any one of a number of methods that are well known to those of ordinary skill in the art) to allow the data consumer to edit the data consumer configuration. In addition, an “Add New Data Consumer” button is displayed to enable the data consumer to create a new data consumer configuration.

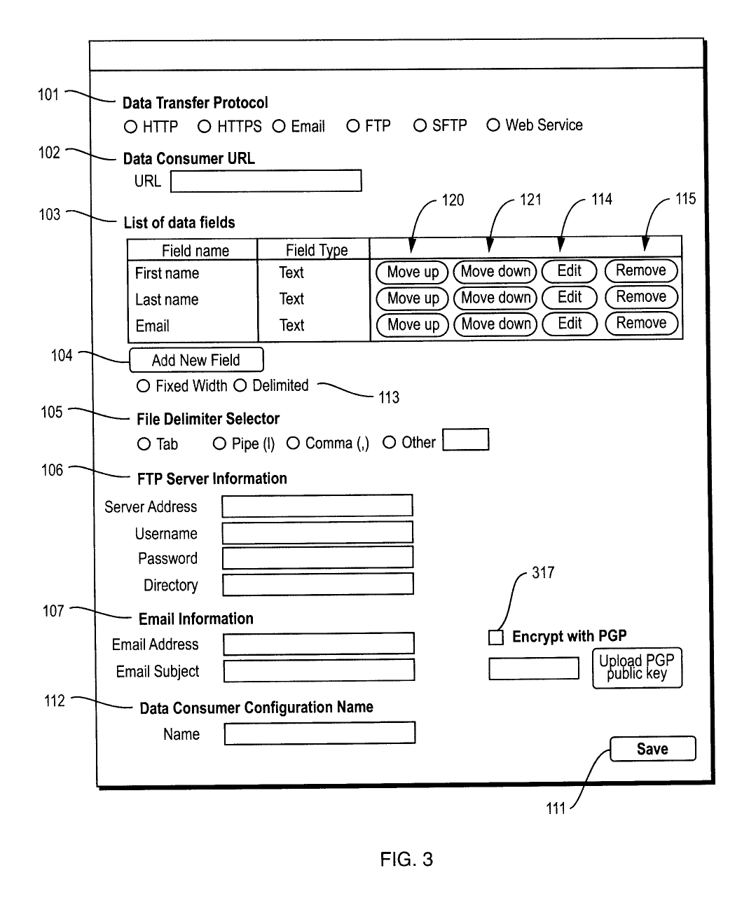

In response to the data consumer's clicking the “Edit” button on the screen shown in FIG. 2, in accordance with one or more embodiments, data consumer configurator 100 presents the screen shown in FIG. 3, pre-populated with the selected data consumer configuration information (in accordance with any one of a number of methods that are well known to those of ordinary skill in the art). In response to the data consumer's clicking the “Add New Data Consumer” button on the screen shown in FIG. 2, in accordance with one or more embodiments, data consumer configurator 100 presents the screen shown in FIG. 3 (in accordance with any one of a number of methods that are well known to those of ordinary skill in the art). FIG. 3 illustrates an instance of a data consumer configuration with Data Transfer Protocol selector 101, Data Consumer URL form 102, List of data fields 103, “Add New Field” button 104, File Delimiter Selector 105, optional FTP Server Information form 106, optional Email Information form 107, and Data Consumer Configuration Name 112. Based on consumer selection from Data Transfer Protocol selector 101, data consumer configurator 100 will conditionally display Data Consumer URL form 102, File Delimiter Selector 105, FTP Server Information form 106, or Email Information form 107. For example, if the consumer selects HTTP or HTTPS from Data Transfer Protocol selector 101, Data Consumer URL form 102 is displayed and File Delimiter Selector 105, FTP Server Information form 106, and Email Information form 107 are not displayed. However, if the consumer selects FTP or SFTP from Data Transfer selector 101, then File Delimiter Selector 105 and FTP Server Information form 106 are displayed, and Data Consumer URL form 102 and Email Information form 107 are not displayed. Lastly, if the consumer selects Email from Data Transfer Selector 101, then File Delimiter Selector 105 and Email Information form 107 are displayed, and Data Consumer URL form 102 and FTP Server Information form 106 are not displayed.

Data Transfer Protocol selector 101 specifies the data transfer protocol that must be used for the data consumer to accept data from computer system 1000. In accordance with one or more embodiments, data consumer configurator 100 displays a list of data transfer protocols (for example and without limitation, FTP, RCP, SFTP, SCP, HTTP, HTTPS, and SOAP via Web Service) from which the data consumer may choose. Data Consumer URL form 102 is the data consumer's web URL which computer system 1000 will use to transfer data to the data consumer if the data consumer selects to transfer data using HTTP or HTTPS POST. List of data fields 103 specifies the data fields that make up a single data record of the data transfer to the data consumer. In accordance with one or more embodiments, on the screen shown in FIG. 3, the data consumer will specify: (a) in case the consumer selects FTP or Email for data transfer protocol, the required ordering of data fields (as shown in the screen shown in FIG. 3) within each row of data (in accordance with one or more embodiments, the data consumer specifies the ordering of data fields by clicking on “Move up” button 120 or “Move down” button 121): (b) data fields to be removed from list of data fields 103 by clicking on “Remove” button 115; and (c) whether to have data fields in fixed-width format or to have data fields be delimited by a chosen character using selector 113. If the data consumer chooses to use delimited data fields by selecting a “Delimited” option for selector 113 on the screen shown in FIG. 3, the data consumer will specify a delimiter character using File Delimiter Selector 105. File Delimiter Selector 105 specifies the delimiter character that will be used to separate the data fields. File Delimiter Selector 105 will be shown only if the data consumer elects to transfer data using FTP or SFTP or email data transfer protocols. The delimiter character can be, for example and without limitation, comma(,), tab(\t), pipe(I), or any other single character of the data consumer's choice (in accordance with any one of a number of methods that are well known to those of ordinary skill in the art).

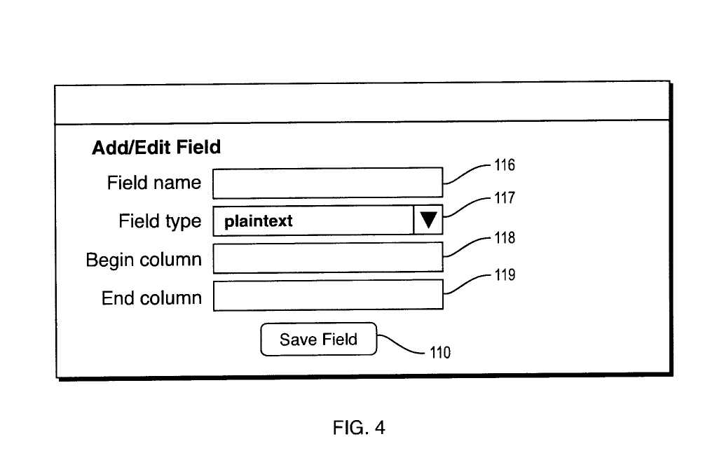

FTP Server Information form 106 includes the FTP server address, FTP server consumername and password, and FTP directory name that will be used by computer system 1000 to transfer data to the data consumer if the data consumer elects to transfer data using FTP or SFTP. Email Information form 107 includes the email addresses and email subject that will be used by computer system 1000 to transfer data to the data consumer if the data consumer elects to transfer data using Email. If the data consumer clicks on “Add New Field” button 104, data consumer configurator 100 will display the screen shown in FIG. 4.

To use the screen shown in FIG. 4, the data consumer will enter a field name in Field name 116, and select a field type using Field type 117. If the data consumer chooses to use a fixed width format by selecting a “Fixed width” option from selector 113 on the screen shown in FIG. 3, data consumer configurator 100 will present a begin column number in Begin column 118 and an end column number in End column 119 for the new field on the screen shown in FIG. 4. The data consumer selects a field type from an existing list of field types in Field type 117 to identify the format of the data field to computer system 1000, examples of field types include text, number, date, phone number, country code, state, zip. After the data consumer clicks “Save field” button 110 on the screen shown in FIG. 4, the data consumer configurator 100 adds the field name to the data consumer configuration, and the new field is displayed on list of fields 103 on the screen shown in FIG. 3. If the data consumer clicks on “Edit” button 114 on the screen shown in FIG. 3, data consumer configurator 100 displays the screen shown in FIG. 4 pre-populated with the selected field name in Field name 116, and a field type in Field type 117. In addition, if the data consumer selects the “Fixed Width” option from selector 113 on the screen shown in FIG. 3, data consumer configurator 100 displays a begin column number in Begin column 118 and an end column number in End column 119 on the screen shown in FIG. 4. After the data consumer clicks on “Save Field” button 110 on the screen shown in FIG. 4, the data consumer configurator 100 stores the changes to the field, and the changes are reflected in List of data fields 103 on the screen shown in FIG. 3. In accordance with one or more embodiments of, the data consumer can choose to receive files securely by having computer system 1000 send files encrypted using the data consumer's PGP key. To do this, the data consumer will select “Encrypt with PGP” checkbox 317 on the screen shown in FIG. 3, and enter an address of a file containing the PGP public key or browse its own system (in accordance with any one of a number of methods that are well known to those of ordinary skill in the art) to find the PGP public key file. In response, data consumer configurator 100 will upload the data consumer's PGP public key, and store it in configuration data store 250. Later, computer system 1000 will use the data consumer's PGP public key to encrypt files to be transferred to the data consumer.

The data consumer enters a human-readable name in Data Consumer Configuration Name form 112 to identify the data consumer configuration in data consumer configurator 100. After entering the required information on the screen shown in FIG. 3, the data consumer clicks on “Save” button 111 to save the data consumer configuration to configuration data store 250.

In accordance with one or more embodiments, data consumer configurator 100 stores the data consumer configuration in machine-readable format (for example and without limitation, in XML or as normalized database tables) in configuration data store 250 (in accordance with any one of a number of methods that are well known to those of ordinary skill in the art). The data components comprising the data consumer configuration are set forth in detail in FIG. 13.

Data Source Section

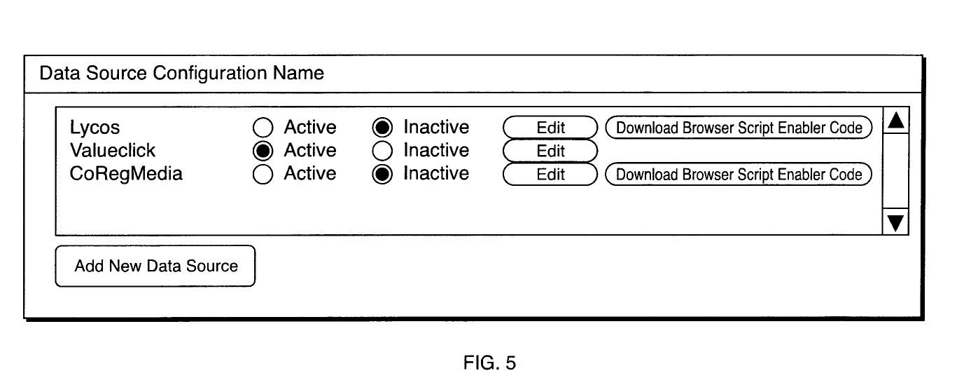

For a data source to initiate a new data source configuration or to edit an existing one, the data source accesses a web interface exposed by data source configurator 200 by clicking on a link to the web interface in a browser. In response, data source configurator 200 queries configuration data store 250 to retrieve all existing data source configurations set up by the data source previously (in accordance with any one of a number of methods that are well known to those of ordinary skill in the art), and data source configurator 200 displays this data as a list in the screen shown in FIG. 5 (in accordance with any one of a number of methods that are well known to those of ordinary skill in the art). As shown in the screen shown in FIG. 5, and in accordance with one or more embodiments, each data source configuration has a name, and a flag (“Active” or “Inactive”) used to indicate to data transfer engine 500 that the data source will send data according to the format and method specified by this data source configuration. In addition, as shown in the screen shown in FIG. 5, an “Edit” button is displayed next to each data source configuration (in accordance with any one of a number of methods that are well known to those of ordinary skill in the art) to allow the data source to edit the data source configuration. In addition, an “Add New Data Source” button is displayed to enable the data source to create a new data source configuration.

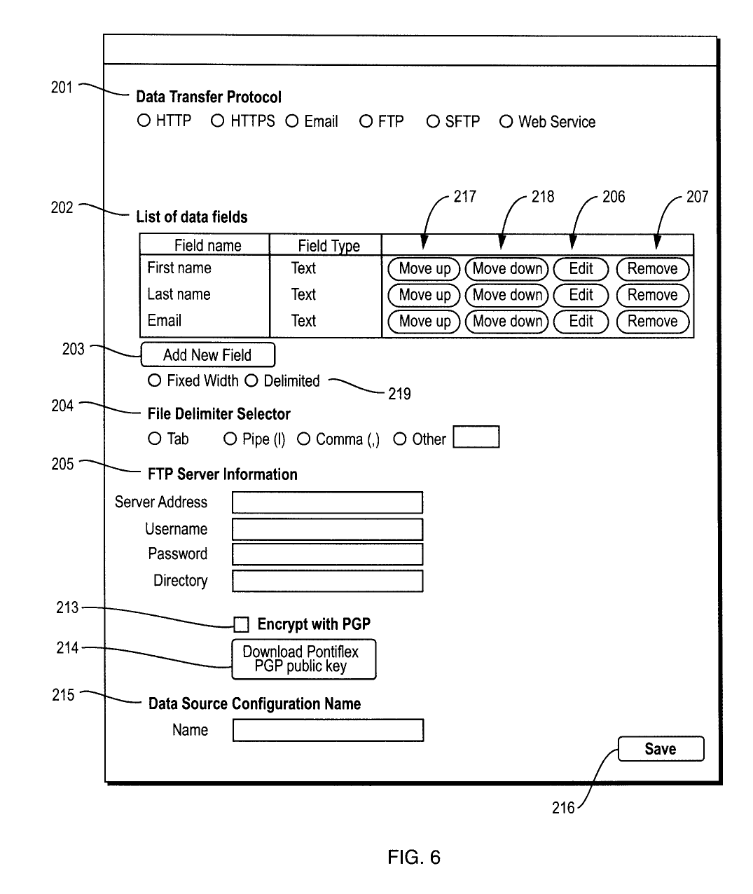

In response to the data source's clicking the “Edit” button on the screen shown in FIG. 5, in accordance with one or more embodiments, data source configurator 200 presents the screen shown in FIG. 6, pre-populated with the selected data source configuration information (in accordance with any one of a number of methods that are well known to those of ordinary skill in the art). In response to the data source's clicking the “Add New Data Source” button on screen shown in FIG. 5, in accordance with one or more embodiments, data source configurator 200 presents the screen shown in FIG. 6 (in accordance with any one of a number of methods that are well known to those of ordinary skill in the art). FIG. 6 illustrates an instance of a data source configuration with Data Transfer Protocol selector 201, List of data fields 202, “Add New Field” selector 203, File Delimiter Selector 204, optional FTP Server Information form 205, and Data Source Configuration Name form 206. Based on data source selection from Data Transfer Protocol selector 201, data source configurator 200 will conditionally display File Delimiter Selector 204 or FTP Server Information form 205. For example, if the data source selects HTTP or HTTPS from Data Transfer Protocol selector 201, File Delimiter Selector 204 and FTP Server Information form 205 are not displayed. However, if the data source selects FTP or SFTP from Data Transfer Protocol Selector 201, then File Delimiter Selector 204 and FTP Server Information form 205 are displayed.

Data Transfer Protocol selector 201 specifies the data transfer protocol that the data source will use to send data to computer system 1000. In accordance with one or more embodiments, data source configurator 200 displays a list of data transfer protocols (for example and without limitation, FTP, RCP, SFTP, SCP, HTTP, HTTPS, and SOAP via Web Service) from which the data source may choose. List of data fields 203 specifies the data fields that make up a single data record of the data transfer from the data source. In accordance with one or more embodiments, on the screen shown in FIG. 6, the data source will specify: (a) in case the data source selects FTP or Email for data transfer protocol, the required ordering of data fields (as shown in the screen shown in FIG. 6) within each row of data (in accordance with one or more embodiments, the data source specifies the ordering of data fields by clicking on “Move up” button 217 or “Move down” button 218); (b) data fields to be removed from List of data fields 202 by clicking on “Remove” button 207; and (c) whether to have data fields in fixed-width format or to have data fields be delimited by a chosen character using selector 219. If the data source chooses to use delimited data fields by selecting a “Delimited” option for selector 219 on the screen shown in FIG. 6, the data source will specify a delimiter character using File Delimiter Selector 204. File Delimiter Selector 204 specifies the delimiter character that will be used to separate the data fields. File Delimiter Selector 204 will be shown only if the data source elects to transfer data using FTP or SFTP or email data transfer protocols. The delimiter character can be, for example and without limitation, comma(,), tab(\t), pipe(I), or any other single character of its choice (in accordance with any one of a number of methods that are well known to those of ordinary skill in the art).

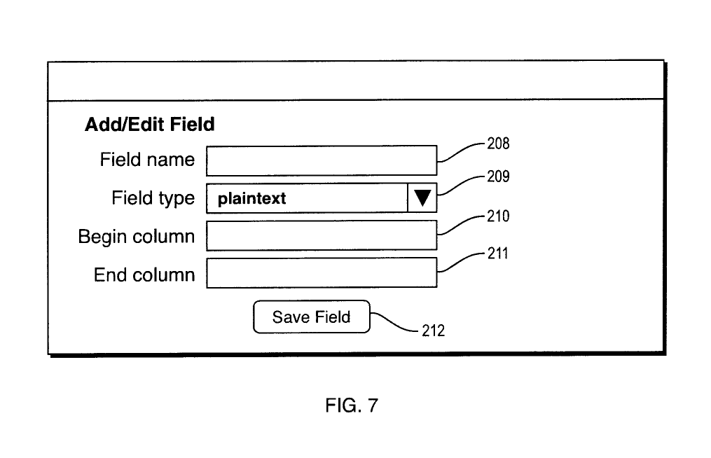

FTP Server Information form 205 includes the FTP server address, the FTP server data sourcename and password, and the FTP directory name that will be used by computer system 1000 to receive data from the data source if the data source elects to transfer data using FTP or SFTP. If the data source clicks on “Add New Field” button 203, data source configurator 200 displays the screen shown in FIG. 7.

To use the screen shown in FIG. 7, the data source will enter the field name Field name 208, and select a field type using Field type 209. If the data source chooses to use a fixed width format by selecting a “Fixed width” option from selector 219 on the screen shown in FIG. 6, data source configurator 200 will present a begin column number in Begin column 210 and an end column number in End column 211 for the new field on the screen shown in FIG. 7. After the data source clicks “Save field” button 212 on the screen shown in FIG. 7, data source configurator 200 adds the field name to the data source configuration, and the new field is displayed on List of data fields 202. If the data source clicks on “Edit” button 206 on the screen shown in FIG. 6, data source configurator 200 displays the screen shown in FIG. 7 pre-populated with the selected field name in Field name 208 and a field type in Field type 209. In addition, if the data source selects the “Fixed Width” option from selector 219 on the screen shown in FIG. 6, data source configurator 200 displays a begin column number in Begin column 210 and an end column number in End column 211 on the screen shown in FIG. 7. After the data source clicks on “Save field” button 212 on the screen shown in FIG. 7, data source configurator 200 stores the changes to the field, and the changes are reflected in List of data fields 202 on the screen shown in FIG. 6. In accordance with one or more embodiments, the data source can choose to send files securely by encrypting files with computer system 1000's public PGP key. To do this, the data source will click “Encrypt with PGP” checkbox 213 on the screen shown in FIG. 6, and click on “Download Pontiflex PGP public key” button 214. In response, the data source will download computer system 1000's public PGP key. In accordance with one or more embodiments, computer system 1000 will decrypt files sent by the data source using computer system 1000's PGP private key.

The data source enters a human-readable name in Data Source Configuration Name form 215 to identify the data source configuration in data source configurator 200. After entering the required information on the screen shown in FIG. 6, the data source clicks on “Save” button 216 to save the data source configuration to configuration data store 250.

In accordance with one or more embodiments, data source configurator 200 stores the data source configuration in machine-readable format (for example and without limitation, in XML or as normalized database tables) in configuration data store 250 (in accordance with any one of a number of methods that are well known to those of ordinary skill in the art). The data components comprising the data source configuration are set forth in detail in FIG. 12.

Data Transfer Section

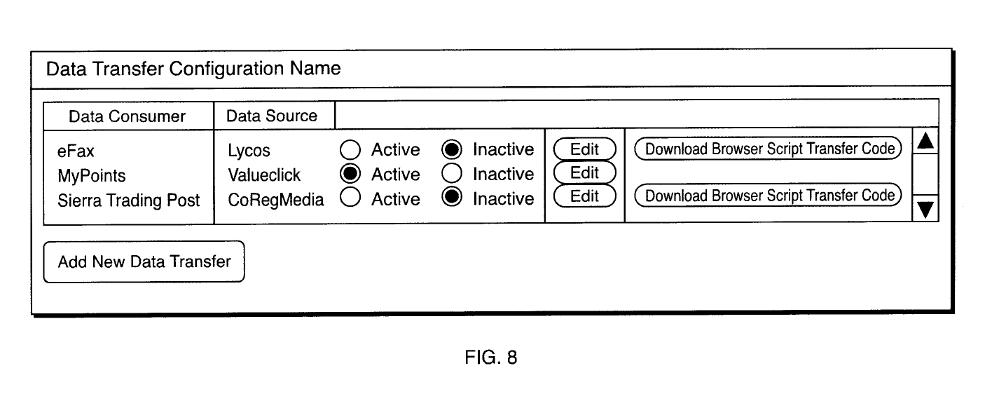

In accordance with one or more embodiments, data transfer configurator 300 is a module of computer system 1000 that exposes an interface, for example and without limitation, a web interface, wherein a user can set up a data transfer from a data source to a data consumer using a pre-existing data source configuration and data consumer configuration from configuration data store 250. In accordance with one or more embodiments, users will use this interface as a set up (for example, one-time set up) tool for each data transfer. A data transfer configuration will need to change only if the data source or the data consumer changes its respective configuration. In accordance with one or more embodiments, an interface (refer to FIG. 8) will display web pages where a user can view its current data transfer configurations, edit these data transfer configurations, and/or add new data transfer configurations.

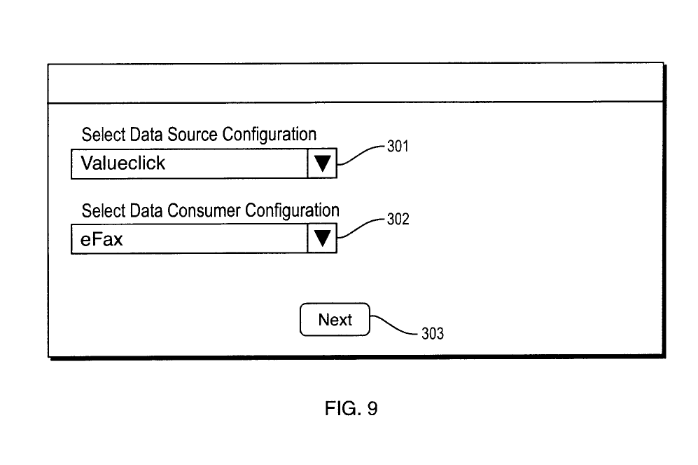

For a user to initiate a new data transfer configuration or to edit an existing one, the user accesses a web interface exposed by data transfer configurator 300 by clicking on a link to the web interface in a browser. In accordance with one or more embodiments, upon a user's initiating a new data transfer configuration, or editing an existing data transfer configuration, data transfer configurator 300 will present web forms requesting information. In accordance with one or more embodiments, first, data transfer configurator 300 displays a screen (refer to FIG. 9). The user selects a data source configuration from a “Select Data Source Configuration” list and selects a data consumer configuration from a “Select Data Consumer Configuration” list. Data transfer configurator 300 creates the “Select Data Source Configuration” list by listing all data source configurations in configuration data store 250 (in accordance with any one of a number of methods that are well known to those of ordinary skill the art). Data transfer configurator 300 creates the “Select Data Consumer Configuration” list by listing all data consumer configurations in configuration data store 250 (in accordance with any one of a number of methods that are well known to those of ordinary skill the art). After selecting a data source configuration and a data consumer configuration, the user clicks on a “Next” button on the screen.

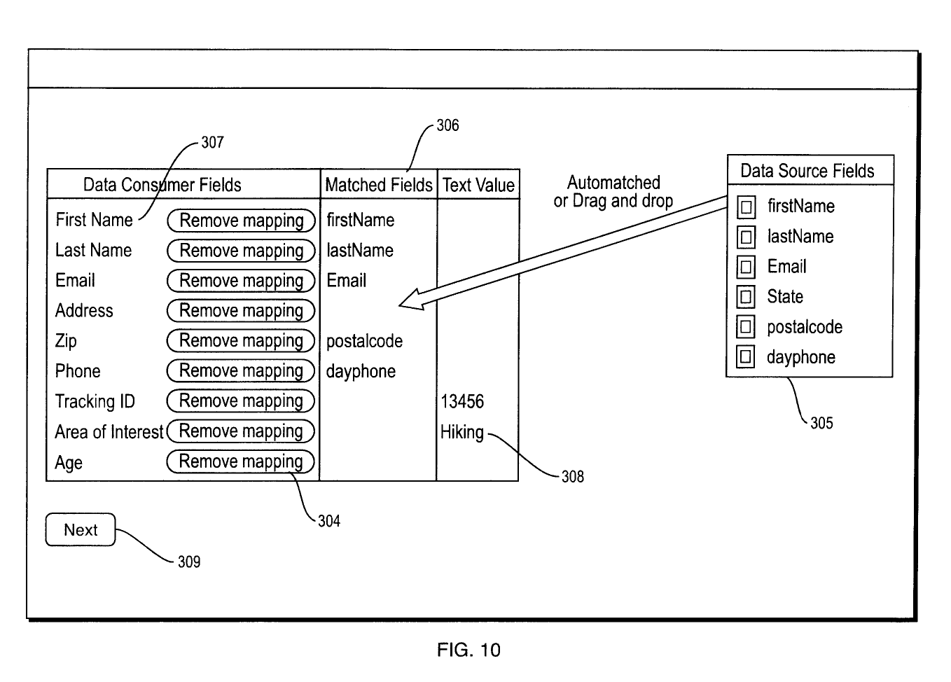

In accordance with one or more embodiments, whenever the user clicks on the “Next” button on the screen, data transfer configurator 300 will map each data field defined in the data consumer configuration selected on the screen to data fields defined in the data source configuration selected in the screen. Data transfer configurator 300 maps a data consumer field to a data source field by selecting the data source field name which best matches the data consumer field name using, for example and without limitation, established and existing implementations of approximate string matching algorithms (in accordance with any one of a number of methods that are well known to those of ordinary skill the art such as, for example and without limitation, those referenced at http://en.wikipedia.org/wiki/Approximate string matching and http://en.wikipedia.org/wiki/agrep, nrgrep, cgrep. After mapping data consumer fields to data source fields, the data transfer configurator 300 displays a screen (refer to FIG. 10) where the user can verify these mappings and modify them if required.

In accordance with one or more embodiments, data transfer engine 500 uses mappings defined on the screen to map data sent by the data source to data sent to the data consumer. In particular, it does this by using a value in the data source field and populating that value in a corresponding data consumer field. In the case where the data consumer field is mapped to a fixed text value instead of a data source field, the fixed text value is used to populate the data consumer field.

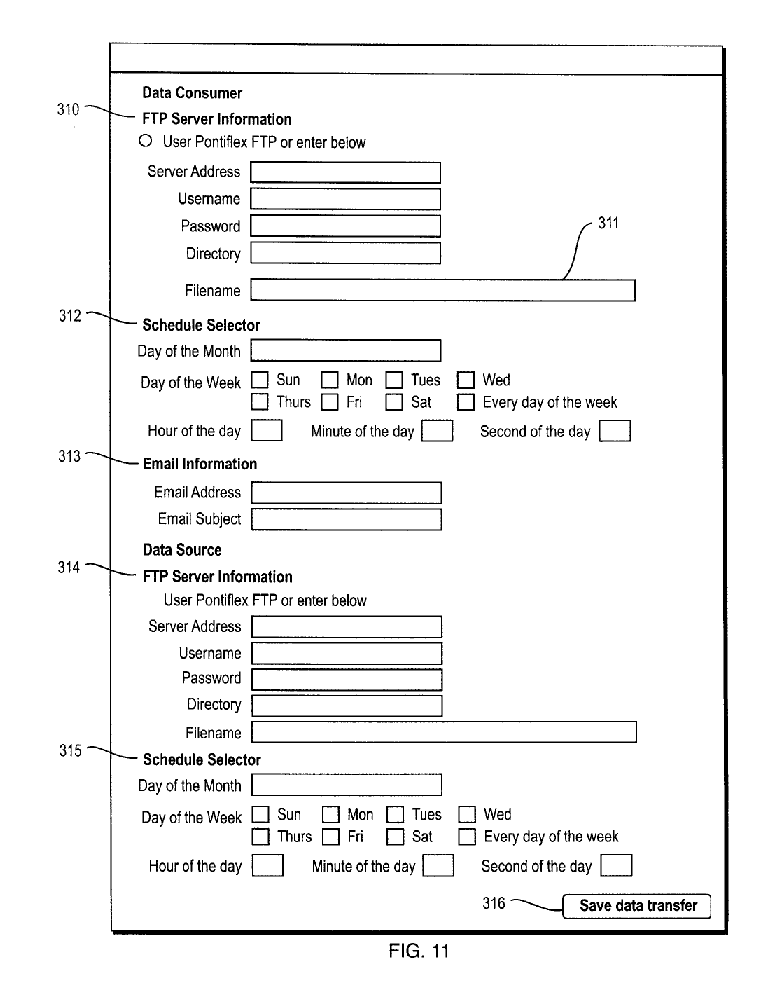

After the user clicks a “Next” button, data transfer configurator 300 presents another screen (refer to FIG. 11). If the data transfer protocol for the selected data consumer from “Select Data Consumer Configuration” list 302 is set up as FTP or SFTP, data transfer configurator 300 will show an FTP Server Information form—the values for the FTP Server Information form will be pre-populated from FTP Server Information from the data consumer configuration. In accordance with one or more such embodiments, the user can override this information by entering a different FTP server address, username, password and/or directory in the FTP Server Information shown on the screen. In addition, the user can also override this information by selecting to use an FTP server provided by computer system 1000. In this case, computer system 1000 will create an FTP username, password and directory in primary data store 600. If the data transfer protocol for the selected data consumer from “Select Data Consumer Configuration” list 302 is set up as FTP or SFTP or Email, data transfer configurator 300 will show a Filename form on the screen. Data transfer engine 500 will use the filename entered in this field to name the files used for the data transfers sent to the data consumer.

If the data transfer protocol for the selected data consumer from “Select Data Consumer Configuration” list 302 is set up as FTP or SFTP or Email, data transfer configurator 300 will show Schedule Selector form 312 wherein the user can specify a schedule in the form of day of month, day of week, and hour/minute/second of day. Data transfer configurator 300 will use the values entered in Schedule Selector form 312 to set up a transfer schedule in data transfer scheduler 400. Data transfer scheduler 400 will send the data transfer to the data consumer using data transfer engine 500 according to the specified schedule. If the data transfer protocol for the selected data consumer from “Select Data Consumer Configuration” list 302 is set up as Email, data transfer configurator 300 will show an Email Information form on the screen. The values for the Email Information form will be pre-populated with email information from the data consumer configuration. The user can override this information by entering a different email address and email subject in the Email Information form on the screen.

If the data transfer protocol for the selected data source from “Select Data Source Configuration” list 301 is set up as FTP or SFTP, data transfer configurator 300 will show an FTP Server Information form on the screen. The values for the FTP Server Information form will be pre-populated from FTP Server Information from the data source configuration. In accordance with one or more such embodiments, the user can override this information by entering a different FTP server address, username, password and/or directory in the FTP Server Information form shown on the screen. In addition, the user can also override this information by selecting to use an FTP server provided by computer system 1000. In this case, computer system 1000 will create an FTP username, password and directory in primary data store 600. If the data transfer protocol for the selected data source from “Select Data Source Configuration” list 301 is set up as FTP or SFTP, data transfer configurator 300 will show Schedule Selector form 315 wherein the user can specify a schedule in the form of day of month, day of week, and hour/minute/second of day. Data transfer scheduler 400 will pull data from the data source using data transfer engine 500 according to the specified schedule. Next, the user clicks a “Save data transfer” button and data transfer configurator 300 saves the data transfer configuration in configuration data store 250.

Finally, in accordance with one or more embodiments, data transfer configurator 300 stores the configuration in machine-readable format (for example and without limitation, in xml or as normalized database tables) in configuration data store 250 (in accordance with any one of a number of methods that are well known to those of ordinary skill in the art). The data components comprising the data transfer configuration is detailed in FIG. 14.

In accordance with one or more embodiments, data transfer scheduler 400 is a module of computer system 1000 that is used in the manner described below for data transfers that are set up to use an FTP, an SFTP or an Email data transfer protocol. According to the schedule specified during data transfer configuration, data transfer scheduler 400 will send data to a data consumer or pull data from a data source.

Data transfer scheduler 400 uses established and pre-existing implementations of job scheduling algorithms such as, for example and without limitation, Unix crontab or jcrontab.

Data transfer engine 500 handles the actual transfer of data from a data source to a data consumer (in accordance with any one of a number of methods that are well known to those of ordinary skill in the art). For a data transfer, a data transfer engine retrieves a data source configuration, a data transfer configuration, and a data consumer configuration from configuration data store 250. Data transfer engine 500 receives data from the data source, transforms the received data into a form required by the data consumer as specified in the data consumer configuration and data transfer configuration, and sends the transformed data to the data consumer. In accordance with one or more embodiments, a data transfer engine is capable of communicating in an open protocol such as, for example and without limitation, FTP, SFTP, RCP, SCP, HTTP, HTTPS, and SOAP.

In accordance with one or more embodiments, primary data store 600 is a module of computer system 1000 that is used when a data source or a data consumer chooses to send data to or receive data from, respectively, computer system 1000 using FTP, SFTP or Email data transfer protocols. In accordance with one or more embodiments, primary data store 600 comprises multiple data stores that are load-balanced (in accordance with any one of a number of methods that are well known to those of ordinary skill in the art). In accordance with one or more embodiments, the data stores of primary data store 600 expose one or more of an FTP, an SFTP, an SCP, an HTTP, an HTTPS, an SMTP, and a Web Service interface (in accordance with any one of a number of methods that are well known to those of ordinary skill in the art). In accordance with one or more embodiments, the interfaces will be exposed by using open source or third party proprietary software such as, for example and without limitation, proftpd (FTP), Apache web server (HTTP, HTTPS), and so forth. In addition, and in accordance with one or more embodiments, all of the data stores of primary data store 600 share a common authentication module for example and without limitation, openldap (LDAP) that is fabricated in accordance with any one of a number of methods that are well known to those of ordinary skill in the art. Advantageously, this enables the same authentication token to be used across multiple data stores in accordance with any one of a number of methods that are well known to those of ordinary skill in the art.

Further, in accordance with one or more embodiments, primary data store 600 can create separate, secure data areas for each data source and data consumer, and can auto-generate credentials in a common authentication module to access these data areas (in accordance with any one of a number of methods that are well known to those of ordinary skill in the art). The credentials are auto-generated during the data transfer configuration process if the user selects to use computer system 1000's FTP server for data transfer.

In accordance with one or more embodiments, where a data source chooses to send data to computer system 1000 via an HTTP or HTTPS data transfer protocol, the data source has an option to send the data to computer system 1000 using a BrowserScriptPost code snippet that will be generated by computer system 1000, and will be available to download by the data source via a computer system 1000-provided web interface (alternatively, computer system 1000 may provide the BrowserScriptPost code snippet by email or a user of computer system 1000 may cause the BrowserScriptPost code snippet to be downloaded). The BrowserScriptPost code snippet provides a mechanism for sending data records directly to computer system 1000, in real time, without the data source's having to write custom backend code. In essence, as will be described below, set up for this functionality involves inserting a few lines of, for example and without limitation, JavaScript into, for example and without limitation, the Success or Thank You page at the end of a deal process flow.

In accordance with one or more embodiments, a BrowserScriptPost code snippet is provided to a data source in a browser based scripting language. For example, where the data source is collecting data via HTML web forms, the BrowserScriptPost code snippet may be provided as a JavaScript code snippet. The data source will insert the BrowserScriptPost code snippet into its HTML web form so that it may be used after the data it is sending to computer system 1000 has been collected by the data source, for example, after a user registration or order form step has been completed. FIG. 15 shows an HTML source code view of a sample data source-owned HTML web page that includes a BrowserScriptPost code snippet that is fabricated in accordance with one or more embodiments. As shown in FIG. 15, the BrowserScriptPost code snippet comprises three components: (a) a first component, data object 901, is an object that contains data to be transferred to computer system 1000 that can be accessed by the browser scripting language; (b) a second component, component 902, is a function that converts data object 901 to a request for an image resource from computer system 1000; and (c) a third component, component 903, is a call to the function defined in component 902 that passes data object 901 as a parameter, thereby effectively sending data collected by the data source in data object 901 to computer system 1000 as part of the image request.

In accordance with one or more embodiments, where the BrowserScriptPost code snippet is provided as a JavaScript code snippet, data object 901 is a JavaScript object which is a collection of properties of key name and value pairs such as, for example and without limitation, data=(name:“name_value”, email:“email_value”, zip:“zip_value”). This JavaScript object is generated for the data source by computer system 1000 by populating the key names as the names of the fields defined by the data source in data source configurator 200 in List of data fields 202 on the screen shown in FIG. 6. The values for the keys will be the data collected by the data source that it wants to send to the data consumer via computer system 1000. The values will be populated by the data source in the JavaScript object using any technology such as, for example and without limitation, JSP, ASP, ASP.NET, PHP that the data source uses to generate the data source's HTML web pages.

In accordance with one or more embodiments, where the BrowserScriptPost code snippet is provided as a JavaScript code snippet, the JavaScript function of component 902 reads the JavaScript object of component 901, and constructs (using any one of a number of methods that are well known to those of ordinary skill in the art) and adds a request for an image file from computer system 1000 to the data source's HTML web page. FIG. 16 shows pseudo code describing the JavaScript function of component 902. The request for the image file resource is constructed as an HTTP GET request with the key and value pairs of the JavaScript object of component 901 added in as parameters to the HTTP GET request. In addition to these GET parameters, a data transfer id identifying the data transfer configuration is also passed as a parameter to the JavaScript function of component 902. This data transfer id is also added as a parameter to the HTTP GET request. The data collected by the data source is thus passed on to computer system 1000 for onward transfer by computer system 1000 to the data consumer specified in the data transfer configuration.

In accordance with one or more embodiments, the data source can download the JavaScript for components 901 and 902 for each data source configuration set up using data source configurator 200 by clicking on the “Download Browser Script Enabler Code” button as shown on the screen shown in FIG. 5.

In accordance with one or more embodiments, where the BrowserScriptPost code snippet is provided as a JavaScript code snippet, component 903 is a call to the JavaScript function defined by component 902, which function accepts, as parameters, the data transfer id and the JavaScript object created by component 901, for example, send(123345, data). In accordance with one or more such embodiments, computer system 1000 will provide an instance of the JavaScript code to the data source for component 903 for each data transfer defined in data transfer configurator 300 that has been configured to accept data from the data source. The data source can download an instance of component 903 for each data transfer configuration by clicking on a “Download Browser Script Transfer Code” button on a screen provided. The unique data transfer id identifying the data transfer is generated by computer system 1000 on creation of a new data transfer configuration, and will be populated by computer system 1000 in each instance of the Java Script code snippet for component 903. For each instance where the data source wants to send collected data in component 901 to computer system 1000, the data source will place calls to the JavaScript function on the web page after placing the JavaScript code for component 901 and 902 using any technologies such as, for example and without limitation, JSP, ASP, ASP.NET, PHP that the data source uses to generate data source's HTML web pages.

Based on the examples given above for component 901 and 903, the HTTP GET request for an image resource from computer system 1000 will be constructed by component 902 as: https://pontiflex.com/scriptpost?transferid=123345 &name=name value&email=email value&zip=zip value.

The image resource request that will be added to the data source's HTML web page will be added as an HTML image tag that will look like <img src=“https://pontiflex.com/scriptpost?transferid=123345 &name=name value&email=email value&zip=zip value”/>.

In accordance with one or more embodiments, archiver 800 runs at a system-defined archival time interval, and moves data; older than the archival time interval, from primary data store 600 to an archival data warehouse of archiver 800 (in accordance with any one of a number of methods that are well known to those of ordinary skill in the art).

What is claimed is:

1. A method for advertising using a mobile device which comprises:
a user causing the mobile device to execute a mobile application;
the mobile application displaying a registration screen on a mobile device display, which registration screen includes one or more capture fields for user data;
using a mobile device user input device, the user entering user data into the one or more capture fields;
the mobile application requesting and receiving one or more advertisements associated with one or more advertisers over the Internet;
the mobile application displaying one or more of the advertisements on the mobile device display, which advertisements include an opt-in offer and an opt-in checkbox;
the user accepting one or more of the opt-in offers by clicking on one or more of the opt-in checkboxes;
the mobile application sending the user data over the Internet to associated advertisers for advertisements whose offers were accepted; and
the mobile application further executing.

2. The method of claim 1 which further comprises:
the mobile application storing the user data.

3. The method of claim 1 which further comprises:
the mobile application validating the user data.

4. The method of claim 3 which further comprises:
the mobile application requesting the user to correct user data that is not valid.

5. The method of claim 1 wherein:
the mobile application sending the user data over the Internet to associated advertisers comprises the mobile application sending the user data over the Internet to a data bridge system.

6. The method of claim 1 wherein:
the mobile application requesting and receiving one or more advertisements over the Internet comprises the mobile application sending a request to an Ad Server computer system and receiving the one or more advertisements from the Ad Server computer system.

7. The method of claim 1 further comprising:
the user causing the mobile device to install a mobile application.

8. A method for advertising using a mobile device which comprises:
a user causing the mobile device to execute a mobile application;
the mobile application requesting and receiving one or more advertisements associated with one or more advertisers over the Internet;
the mobile application displaying one or more of the advertisements on the mobile device display, which advertisements include an opt-in offer and an opt-in checkbox;
the user accepting one or more of the opt-in offers by clicking on one or more of the opt-in checkboxes;
the mobile application determining whether the user had previously submitted user data;
if not,
the mobile application displaying a registration screen on a mobile device display, which registration screen includes one or more capture fields for user data; and
using a mobile device user input device, the user entering user data into the one or more data capture fields;
if yes,
the mobile application sending the user data over the Internet to associated advertisers for advertisements whose offers were accepted; and
the mobile application resuming execution.

9. The method of claim 8 which further comprises:
the mobile application storing the user data.

10. The method of claim 8 which further comprises:
the mobile application validating the user data.

11. The method of claim 10 which further comprises:
the mobile application requesting the user to correct user data that is not valid.

12. The method of claim 8 wherein:
the mobile application sending the user data over the Internet to associated advertisers comprises the mobile application sending the user data over the Internet to a data bridge system.

13. The method of claim 8 wherein:
the mobile application requesting and receiving one or more advertisements over the Internet comprises the mobile application sending a request to an Ad Server computer system and receiving the one or more advertisements from the Ad Server computer system.
